(19) United States
(12) Patent Application Publication
(10) Pub. No.: US 2024/0127153 A1
(43) Pub. Date: Apr. 18, 2024

(54) SYSTEMS AND METHODS FOR AUTOMATED RISK ASSESSMENT IN MACHINE LEARNING

(71) Applicant: Themis AI, Inc., Cambridge, MA (US)

(72) Inventors: Alexander Andre Amini, Brookline, MA (US); Sadhana Lolla, Cambridge, MA (US); Iaroslav Elistratov, Alanya (TR); Alejandro Perez, Manchester, NH (US); Elaheh Ahmadi, Belmont, MA (US); Daniela Rus, Weston, MA (US)

(21) Appl. No.: 18/478,301

(22) Filed: Sep. 29, 2023

Related U.S. Application Data
(60) Provisional application No. 63/411,188, filed on Sep. 29, 2022.

(51) Int. Cl. G06Q 10/0635

(52) U.S. Cl. CPC G06Q 10/0635

(57) ABSTRACT

Disclosed are techniques, and related systems, for developing and implementing a unified framework for quantifying risk in machine learning models, such as deep neural networks. The framework can be easy-to-use and flexible to apply to different types of machine learning models. The framework can be used to automatically assess different forms of risk in parallel, including but not limited to aleatoric uncertainty, epistemic uncertainty, and/or vacuitic uncertainty. To that end, the disclosed framework provides wrappers that compose different automatic risk assessment algorithms. The obtained risk estimates can be used, for example, for: providing a deeper insight into decision boundaries of neural networks; performing downstream tasks by integrating the risk estimates back into a learning lifecycle for the model to improve robustness and generalization; and/or improving safety by identifying potential model failures based on the risk values.

### CROSS REFERENCE TO RELATED APPLICATION

The present disclosure claims priority to U.S. Provisional Patent Application No. 63/411,188, entitled “System and Method for Automated Risk Assessment in Machine Learning,” which was filed on Sep. 29, 2022, and which is incorporated by reference herein in its entirety.

### TECHNICAL FIELD

This disclosure generally describes devices, systems, and methods related to computer-automated techniques for quantifying one or more risk assessments in machine learning, such as different types of deep neural networks (DNNs).

### BACKGROUND

Neural networks (NNs) continue to push boundaries of modern artificial intelligence (AI) systems across a wide range of real-world domains, such as robotics, autonomy, healthcare, and medical decision making. While their performance in such domains is beneficial, sometimes NNs can experience unexpected and/or inexplicable failures, particularly in challenging scenarios and/or safety-critical environments. Such failures can be due, at least in part, to systemic issues that may propagate throughout an entire AI lifecycle, from imbalances and noise in data that may lead to algorithmic bias to predictive uncertainty in model performance on unseen and/or out-of-distribution data.

Some algorithms can be used to achieve risk-awareness of NNs, but may be complex and ad-hoc. For example, these algorithms may require significant engineering changes, may be developed only for particular settings, and/or may not be easily composable. These algorithms may sometimes take three (3) or more months to transform a model into its risk aware variant and to perform uncertainty estimations because such algorithms require time-consuming manual modifications of the model in question. The three or more months may also encapsulate other actions including, but not limited to, modifying an architecture, training and/or updating applied weights, debugging, testing (e.g., testing for deployment), evaluating, and/or benchmarking with previous architecture versions, preparing for deployment, and/or collecting feedback. Existing algorithmic approaches may additionally or alternatively narrowly estimate a singular form of risk in AI models, often in the context of a limited number of data modalities. These methods may present critical limitations as a result of their reductionist, ad hoc, and narrow focus on single metrics of risk or uncertainty. On the other hand, generalizable methods that provide a larger holistic awareness of risk have yet to be realized and deployed, which is in part due to significant engineering changes that may be required to integrate an individual risk algorithm into a larger machine learning system (which in turn can impact quality and reproducibility of results). Some approaches to risk estimation specialize on a particular type of model architecture and/or specialize on particular layers of the model, requiring manual time-consuming modifications to be performed on the part of the user to apply these approaches to other layers and model architectures. A lack of a unified algorithm for composing different risk estimation algorithms or risk-aware models limits scope and capability of each algorithm independently, and further may limit robustness of the system as a whole.

Accordingly, there is a need for unified systems, and related methods, that can automatically estimate and/or quantify various risk metrics for any NN model or other machine learning algorithms.

### SUMMARY

The disclosure generally describes technology for a unified framework for quantifying risk in machine learning, such as deep neural networks. The framework may remain the same, however at least one wrapper implemented using the framework can have multiple different instantiations. More specifically, the disclosed technology provides a flexible, easy-to-use framework for extending different types of machine learning algorithms with calibrated risk-awareness and assessment of different forms of risk. The disclosed technology can be used to implement a model-agnostic framework for extending NN systems with holistic risk-awareness, covering uncertainty, bias, and/or other risk metrics (e.g., label noise, predictive uncertainty), to improve ability and robustness of end-to-end systems. The disclosed technology can provide for quantifying multiple forms of risk and composing different algorithms together to quantify different risk metrics in parallel.

For example, the disclosed framework may compose algorithms for aleatoric uncertainty, epistemic uncertainty, and/or bias estimation (also referred to as vacuitic uncertainty) together in a single function to provide a comprehensive awareness of NN risk. The disclosed technology can be validated by implementing one or more empirical uncertainty estimation algorithms within the disclosed framework and benchmarking them on complex datasets, including, but not limited to, perception datasets. NN models can be improved to not only identify potential failure in models, but also effectively use this awareness to obtain unified and calibrated measures of risk and uncertainty. This awareness can be integrated back into a learning lifecycle for the NN models to improve robustness, generalization, and/or safety during real-time implementation and use of such NN models.

The devices, system, and techniques described herein may provide one or more of the following advantages. For example, the use of different wrappers allows for assessment of different types of risk in different types of models. The wrappers may be configured to apply risk assessments to computational operations of the model. Traditionally users may apply a specific risk estimation algorithm to one layer of their model at a time (e.g., the bottom layer). In such scenarios, the users may need to manually repeat the steps above every time: the model architecture or its hyperparameters change; and/or every time when applying a different risk estimation algorithm is desired. This traditional approach can be time-consuming. The disclosed technology, on the other hand, can represent a model as a graph of mathematical operations that the model performs and then automatically modify this graph to make the model risk aware. By using this framework, risk assessment of the model can be efficiently and quickly performed automatically, such as in approximately one second of computing time (where typically it may take several months for users to manually go layer-by-layer and rewrite their code to perform each individual type of risk assessment).

Moreover, the disclosed technology can provide a model agnostic framework that can be applied to different types of model architectures. The disclosed technology is not merely a set of rules that can automate quickly. The disclosed technology provides an algorithm that may work across different model architectures and across different machine learning frameworks. Users may write models in different deep learning frameworks (e.g., PYTORCH, TENSORFLOW, JAX, or others). Each framework used by the users can have common capabilities. Therefore, the disclosed technology can take the users' models and convert them to a framework-agnostic representation that does not vary across different frameworks. This allows the same risk assessment operations to be executed for each of the different deep learning frameworks. The disclosed technology can also provide for translating the user models (e.g., arbitrary models) back to their original frameworks once the risk assessments are performed.

As another example, the disclosed technology provides an algorithmic framework for wrapping any arbitrary NN model or other machine learning model with risk-awareness capabilities. By decomposing the algorithm stages of risk estimation into their core building blocks/modular components (e.g., different types of risk), different algorithms and estimation metrics can be unified under a common data-centric paradigm. The disclosed technology has no assumptions about specific model architectures, used by the users, and thus the algorithm automatically generalizes to any arbitrary (not previously seen) model architecture without any additional efforts on the part of the user. Additionally, because this framework can render an underlying model aware of a variety of risk metrics in parallel, the accuracy, robustness, efficiency, and/or quality in risk estimation of the model can be improved through principled redundancy. The disclosed technology may also achieve a unified composition and hierarchical understanding of NN and other machine learning risk(s).

As another example, the disclosed technology may be used to automatically identify mislabeled and/or ambiguous data in a training dataset. The disclosed technology may be used to accurately and efficiently determine over-represented features and/or samples, which can include information that may be considered to reduce size of the training dataset and thus training time. Moreover, the disclosed technology may improve overall accuracy and performance of a model by setting one or more risk requirements on model output. The disclosed technology may be used to sort unlabeled data samples (while also preparing labels for training) according to how useful such samples may be for the model (e.g., over and/or under-represented). Sorting the unlabeled data samples may also include prioritizing the samples that the model is uncertain about, thus indicating additional data may prove useful. The disclosed technology may also be used to identify adversarial inputs, such as inputs that the model has difficulty processing. The disclosed technology may provide additional, more granular identification and assessment of parts of the model that may cause varying degrees of uncertainty, as well as the identification and assessment of when such parts cause the uncertainty. The disclosed technology may be used to prevent failures before they occur when using the model (e.g., halting and/or requesting human intervention when model outputs indicate high uncertainty). Furthermore, the disclosed technology may be used to automatically and efficiently sort generated responses from a model during deployment to prioritize highly confident predictions over less confident predictions.

In use, a program that implements the disclosed technology packages different uncertainty methods into “wrappers” that can be applied and scaled across any model, without needing to change the original model to account for the “wrappers” and/or without needing to implement the uncertainty estimation method(s) manually. Rather, the disclosed technology allows a user to implement his/her/its model as normal, and then wrap it with one or more uncertainty estimators provided for the program enabled herein. The disclosed technology re-engineers the original model so it can estimate its own uncertainty, allowing a user to know exactly when the model (or data) is not confident and should not be trusted.

One or more embodiments described herein can include a method for performing a risk assessment on a machine learning model. The method includes receiving, by a computer system from at least one of a user device or a data store, a user model and a list of one or more risk metrics, the one or more risk metrics indicating types of risk factors to assess for the user model. The method also includes selecting, by the computer system, a composable wrapper from a group of composable wrappers for wrapping the user model based on a risk metric in the list of risk metrics, each of the group of composable wrappers corresponding to a different type of risk factor, each of the group of composable wrappers being configured to modify mathematical operations that the user model computes. Still further, the method includes applying, by the computer system and for the selected composable wrapper, a wrapper-specific algorithm to the user model to generate a risk-aware variant of the user model. Applying the wrapper-specific algorithm to the user model includes modifying the mathematical operations computed by the user model to produce a risk estimate for the user model and predictions of the user model. Additionally, the method includes returning, by the computer system, the risk-aware variant of the user model.

The embodiments described herein can optionally include one or more of the following features identified hereafter. For example, modifying the mathematical operations computed by the user model to produce a risk estimate for the user model and predictions of the user model can include modifying a computational graph of the user model. Modifying a computational graph of the user model can include using a shared feature extractor to do at least a portion of the modifying a computational graph of the user model. Modifying the mathematical operations computed by the user model to produce a risk estimate for the user model and predictions of the user model can include using a shared feature extractor to do at least a portion of the modifying the mathematical operations. This is true even if modifying a computation graph of the user model is not included as part of the method. In at least some embodiments, modifying the mathematical operations computed by the user model to produce a risk estimate for the user model and predictions of the user model can include modifying higher-level abstractions of a deep learning library for the user model, with the higher-level abstractions including layers and/or modules. Further, modifying the higher-level abstractions can cause modification of a computational graph of the user model and/or creation of additional computational graphs of the user model.

In at least some implementations, modifying the mathematical operations computed by the user model to produce a risk estimate for the user model and predictions of the user model can include modifying abstractions of a particular programming language of the user model, with the abstractions of the particular programming language including at least one of PYTHON abstract syntax trees, PYTHON concrete syntax trees, PYTHON code, and/or C++ code. The method can also include extracting, by the computer system, a shared backbone model from the user model, extracting, by the computer system, features from input with the shared backbone model, and providing, by the computer system, the shared backbone model to one or more of the group of composable wrappers to generate the risk-aware variant of the user model.

The group of composable wrappers can include a wrapper that can determine vacuitic uncertainty associated with the user model based on output of the risk-aware variant of the user model. Alternatively, or additionally, the group of composable wrappers can include a wrapper that can be configured to determine epistemic uncertainty associated with the user model based on output of the risk-aware variant of the user model. Still further alternatively, or additionally, the group of composable wrappers can include a wrapper that can be configured to determine aleatoric uncertainty associated with the user model based on output of the risk-aware variant of the user model. Any combination of these three wrapper types is possible, including multiple of one or more of any of the three wrapper types.

The method can also include one or more of the following actions to occur iteratively: determining, by the computer system, whether the list of risk metrics includes another risk metric; in response to determining that the list of risk metrics includes the another risk metric, selecting, by the computer system, another composable wrapper from the group of composable wrappers based on the another risk metric; and applying, by the computer system and for the selected another composable wrapper, another wrapper-specific algorithm to the risk-aware variant of the user model. Applying the wrapper-specific algorithm to the user model can include at least one of searching, adding, deleting, and/or replacing one or more nodes or subgraphs of the user model. The method can also include the following actions: receiving, by the computer system, user inputs associated with the user model, the user input including training data having inputs and ground truth labels; executing, by the computer system, the risk-aware variant of the user model based on the user inputs; jointly optimizing, by the computer system, the risk-aware variant of the user model on one or more associated losses; and returning, by the computer system, the optimized model. Jointly optimizing, by the computer system, the risk-aware variant of the user model on one or more associated losses can include computing a combined loss of an average of user-specified losses and wrapper losses for the risk-aware variant of the user model, computing a gradient of the combined loss regarding one or more parameters of the risk-aware variant of the user model, and updating one or more trainable parameters of the risk-aware variant of the user model based on the computed gradient.

In some implementations, the user model can be at least one of a machine learning model and/or a deep learning model. The at least one of a machine learning model and/or a deep learning model can include a neural network (NN).

One or more embodiments described herein includes a system for generating a risk-aware variant of a machine learning model that includes a computer system having memory and processors, with the processors being configured to execute instructions that cause the computer system to perform operations. The operations include receiving, from at least one of a user device or a data store, a user model and a list of one or more risk metrics, with the one or more risk metrics indicating types of risk factors to assess for the user model. The operations further include selecting a composable wrapper from a group of composable wrappers for wrapping the user model based on a risk metric in the list of risk metrics. At least some of the group of composable wrappers correspond to different types of risk factors, and each of the group of composable wrappers are configured to modify mathematical operations that the user model computes. The operations also include applying, for the selected composable wrapper, a wrapper-specific algorithm to the user model to generate a risk-aware variant of the user model. Further, applying the wrapper-specific algorithm to the user model includes modifying the mathematical operations computed by the user model to produce a risk estimate for the user model and predictions of the user model. In at least some embodiments, the operations can further include iteratively performing one or more of the following actions: determining whether the list of risk metrics includes another risk metric; in response to determining that the list of risk metrics includes the another risk metric, selecting another composable wrapper from the group of composable wrappers based on the another risk metric; and applying, for the selected another composable wrapper, another wrapper-specific algorithm to the risk-aware variant of the user model, and returning the risk-aware variant of the user model.

The system can optionally include one or more of the following features identified hereafter. For example, applying the wrapper-specific algorithm to the user model can include applying one or more model modifications to the user model to generate a modified user model, applying one or more model augmentations to the modified user model to generate an augmented user model, and applying a loss function modified to the augmented model to generate the risk-aware variant of the user model. Applying the wrapper-specific algorithm to the user model can include providing an entire user model to the selected composable wrapper. The operations can also include extracting a shared model backbone from the user model and providing the shared model backbone to the selected composable wrapper to generate the risk-aware variant of the user model. In at least some implementations, the operations can include computing a wrapper loss value based on executing the selected composable wrapper, and jointly optimizing the user model on at least the wrapper loss value.

As another example, the operations can include receiving user inputs associated with the user model, with the user inputs including training data having inputs and ground truth labels, extracting features for the user model based on executing a shared model backbone on the user input, receiving user model predictions by applying at least one original last layer of the user model to the extracted features, computing a user-specified loss value, and jointly optimizing the user model on the user-specified loss value. Jointly optimizing the user model on the user-specified loss value can include computing a combined loss as an average of the user-specified loss value and a wrapper loss value, computing a gradient of the combined loss regarding one or more risk-aware model parameters, and updating one or more trainable parameters of the risk-aware variant of the user model, including the shared model backbone, based on the computed gradient.

The action of modifying the mathematical operations computed by the user model to produce a risk estimate for the user model and predictions of the user model can include modifying a computational graph of the user model. Modifying a computational graph of the user model can include using a shared feature extractor to do at least a portion of the modifying a computational graph of the user model. Modifying the mathematical operations computed by the user model to produce a risk estimate for the user model and predictions of the user model can include using a shared feature extractor to do at least a portion of the modifying the mathematical operations. This is true even if modifying a computation graph of the user model is not included as part of the method.

One or more embodiments described herein includes a system for performing a risk assessment on a machine learning model that includes a computer system having memory and processors, with the processors being configured to execute instructions that cause the computer system to perform operations. The operations include receiving, from at least one of a user device or a data store, an arbitrary model and a list of one or more risk metrics, with the one or more risk metrics indicating types of risk factors to assess for the arbitrary model. The operations further include, wrapping the arbitrary model in a composable wrapper, with the composable wrapper being configured to modify mathematical operations that the arbitrary model computes. The operations also include converting, based on execution of the composable wrapper, the arbitrary model into a risk-aware variant of the arbitrary model. This converting action further includes applying a wrapper-specific algorithm of the composable wrapper to the arbitrary model, and modifying the mathematical operations computed by the arbitrary model to produce a risk estimate for the arbitrary model and predictions of the arbitrary model. The operations performed by the processors still further includes returning the risk-aware variant of the arbitrary model.

The system can optionally include one or more of the following features identified hereafter. For example, the operation of wrapping the risk-aware variant in the composable wrapper can include performing one or more wrapper-specific modifications to an architecture of the arbitrary model, and at least one of creating, modifying, and/or combining existing loss functions for the arbitrary model. The action of performing the one or more wrapper-specific modifications to the architecture of the arbitrary model can include at least one of: replacing one or more deterministic weights in the arbitrary model with stochastic distributions; adding, deleting, replacing, and/or a combination thereof, one or more layers of the arbitrary model; and/or augmenting the arbitrary model, where augmenting the arbitrary model can include adding one or more extra layers to the arbitrary model. The operations may also include performing a loss function. Performing the loss function can include combining a user-specified loss function with a wrapper-specific loss function, and/or modifying a current loss function of the arbitrary model with a reconstruction loss. Such actions (i.e., combining and/or modifying) can be integrated into a custom wrapper-specific forward pass through the arbitrary model.

In at least some implementations, the operations can further include calculating, based on execution of the composable wrapper and using the risk-aware variant of the arbitrary model, one or more risk factors associated with the arbitrary model, and returning, to at least a display device, the risk factors associated with the arbitrary model. The risk-aware variant can include a shared model backbone used by the composable wrapper to calculate the one or more risk factors. The one or more risk factors can include at least one of vacuitic uncertainty, aleatoric uncertainty, and/or epistemic uncertainty. Calculating one or more risk factors associated with the arbitrary model further can include calculating a ground truth label for the arbitrary model.

The risk metrics can correspond to the composable wrapper. In at least some embodiments, the action of augmenting the arbitrary model can include at least one of adding, deleting, replacing, and/or a combination thereof, one or more nodes and/or one or more subgraphs of the arbitrary model. Alternatively, or additionally, the action of augmenting can be based on a type of risk factor associated with the composable wrapper. In at least some implementations, converting the arbitrary model into the risk-aware variant can include extracting features from each layer of the arbitrary model to generate the risk-aware variant. The arbitrary model can be at least one of a machine learning model and/or a deep learning model. The at least one of a machine learning model and/or a deep learning model can include a neural network (NN). In at least some embodiments, the action of converting the arbitrary model into a risk-aware variant of the arbitrary model can be further based on using a shared feature extractor

The operations can also include returning the one or more risk factors associated with the arbitrary model based on transmitting instructions to a user device of a user associated with the arbitrary model that, when executed by the user device, can cause the user device to present the one or more risk factors in a graphical user interface (GUI) display. In at least some embodiments, the operations can include automatically adjusting the arbitrary model based on the one or more risk factors and returning the adjusted model.

The action of modifying the mathematical operations computed by the arbitrary model to produce a risk estimate for the arbitrary model and predictions of the arbitrary model can include modifying a computational graph of the arbitrary model. Modifying a computational graph of the arbitrary model can include using a shared feature extractor to do at least a portion of the modifying a computational graph of the arbitrary model. Modifying the mathematical operations computed by the arbitrary model to produce a risk estimate for the arbitrary model and predictions of the arbitrary model can include using a shared feature extractor to do at least a portion of the modifying the mathematical operations. This is true even if modifying a computation graph of the arbitrary model is not included as part of the method.

The details of one or more implementations are set forth in the accompanying drawings and the description below. Other features and advantages will be apparent from the description and drawings, and from the claims.

### BRIEF DESCRIPTION OF THE DRAWINGS

This disclosure will be more fully understood from the following detailed description, taken in conjunction with the accompanying drawings, in which:

FIG. 1A is a conceptual diagram of a system for performing risk assessment of a machine learning model;

FIG. 1B is another conceptual diagram of a system for performing risk assessment of a machine learning model;

FIG. 2A is a flowchart of a process for applying an implementation of a wrapper (at initialization stage) to a machine learning model;

FIG. 2B is a flowchart of a process for applying an implementation of wrapper composability (at initialization stage) to a machine learning model;

FIG. 2C is a flowchart of an implementation of wrapper composability (during training stage);

FIG. 3 is a conceptual diagram for performing risk assessment for a machine learning model;

FIG. 4 is a conceptual diagram of a process for applying an implementation of wrapper composability (at initialization stage), visualized differently than FIG. 2B;

FIG. 5 illustrates example bias and epistemic uncertainty risk assessment results using the disclosed technology;

FIG. 6 illustrates example aleatoric uncertainty risk assessment results using the disclosed technology;

FIG. 7 illustrates example risk metrics on cubic regression using the disclosed technology;

FIG. 8A illustrates example risk estimation on monocular depth prediction using the disclosed technology;

FIG. 8B illustrates example robustness under adversarial noise using the disclosed technology;

FIG. 9 illustrates de-biasing facial recognition systems using the disclosed technology;

FIG. 10 illustrates example mislabeled data in a dataset, which can be assessed using the disclosed technology;

FIG. 11A is a flowchart of a process for applying an alternative implementation of a wrapper (at initialization stage) to a machine learning model;

FIG. 11B is a flowchart of a process for applying an alternative implementation of wrapper composability (at initialization stage) to a machine learning model;

FIG. 11C is a conceptual diagram of a process for applying an alternative implementation of wrapper composability (at initialization stage), visualized differently than FIG. 11B;

FIG. 11D is a flowchart of an alternative implementation of wrapper composability (during training stage);

FIG. 12 illustrates example noise and mislabeled data, which can be identified using the aleatoric method techniques described herein;

FIG. 13 is a system diagram of components that can be used to perform the disclosed technology; and

FIG. 14 is a schematic diagram that shows an example of a computing device and a mobile computing device.

### DETAILED DESCRIPTION OF ILLUSTRATIVE EMBODIMENTS

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Unless otherwise defined, all technical terms used herein have the same meaning as commonly understood by one of ordinary skill in the art to which this disclosure belongs.

In supervised learning, a labeled dataset of n input can output pairs, [symbol] . A model, f, can be learned and parameterized by weights, W, which minimizes an average loss over the entire dataset: Σᵢ [symbol] f\dot{w}(x),y). While traditionally, the model, such as a neural network, outputs predictions in the form of ŷ=f_{W} (x), a risk-aware transformation operation, Φ, can be introduced, which transforms the model, f, into a risk-aware variant, such that:

g=Φ_{θ}(f_{W}),

[symbol]

, R=g(x),

where R are estimated “risk” measures from a set of metrics, θ. A common transformation backbone for Φ_{θ}(·) can be used, which can automatically transform an arbitrary model, f, to be aware of risks, θ. One or more measures of risk can aim to capture, at least on some level, how trustworthy a given prediction may be from a model. This can stem from a data source itself (e.g., aleatoric uncertainty, or vacuitic uncertainty) and/or a predictive capacity of the model itself (e.g., epistemic uncertainty). Accordingly, the above equation may be used to wrap the model (e.g., once), then the wrapped model can take in the same inputs as the original model.

Using the disclosed technology, various risk metrics can be defined as isolating and measuring the various different sources of risk. As described herein, wrappers can be used, which are instantiations of Φ_{θ}, for a singular risk metric, θ.

A wrapper is an algorithm that may be applied to a machine learning model and which may contain a sequence of instructions to transform that model into its risk aware variant, enabling the transformed model to output a risk estimate in addition to the outputs of the original model. In some implementations, the algorithm can have some or all of the following properties: (i) model agnostic (e.g., the same instructions can be applied to any arbitrary machine learning model/architecture without a need to change or otherwise adapt the algorithm), (ii) metric specific (e.g., estimates a specific, single form of risk; composing multiple wrappers allows to estimate multiple forms of risk), and (iii) automatic (e.g., no user intervention may be needed to transform the model). The disclosed technology makes no assumptions about and thus is not limited to, among others: (a) specific internal data structure representation of the model inside a wrapper and/or (b) specific transformations, or a specific way of applying these transformations inside a wrapper. (a) and (b) may have multiple possible concrete instantiations, and thus may vary depending, at least in part, on a specific implementation of the disclosed technology.

An illustrative implementation may include translating a model into a representation and/or a data structure that may be most convenient to express modification instructions (e.g., depending on a chosen programming language and/or a chosen way of applying transformations) for a specific implementation of the disclosed technology. Some implementations may frame a problem of transforming a model into its risk aware variant as modifications of this model's computational graph directly (as opposed to modifying code that generated the graph, which is a more traditional manual method of making a model risk aware). Equivalently, the disclosed technology may not be limited to modifying only the graph representation. Other representations can be chosen to be modified: e.g., (i) PYTHON'S ASTs, (ii) bytecode, (iii) abstractions inside a particular deep learning framework like layer objects (e.g., torch.nn.*, tf.keras.layers.*, and alike), and others. All of the above may be tractable to modify algorithmically, as opposed to algorithmically re-writing raw user code. Accordingly, the disclosed technology leverages the fact that it is tractable to write an algorithm that transforms the above mentioned (or similar) representations since such representations only have a small set of defined semantics that can be modeled algorithmically, and it is not tractable to create an algorithm that re-writes code directly at least because such code may contain rich syntax that can be challenging to model programmatically.

In some illustrative examples, wrapper methods can evaluate multiple models or other data elements using procedures that add and/or remove predictors to find an optimal combination that maximizes model performance. Wrappers can be given an arbitrary NN or other machine learning model and, while preserving the structure and function of the NN, add and modify the relevant components of the model to be a drop-in replacement while also being able to estimate the risk metric, θ. Furthermore, the wrappers can be used to modify computational graphs of models that they are applied to, so that the computational graphs can proceed according to one or more (rules, algorithms, models, and/or processes) defined in the wrappers, without needing to directly modify user's code which generated these graphs. Wrappers can also be composed using a set of metrics, θ, that may be faster and more accurate than individual metrics. Each of the wrappers provided for herein (e.g., aleatoric, epistemic, representation bias) can be trained from scratch if desired. Further, each of the wrappers can be data-agnostic and/or model-agnostic, and further, each of the wrappers have been successfully tested on different models, including vision, language, graphs, and generative AI models.

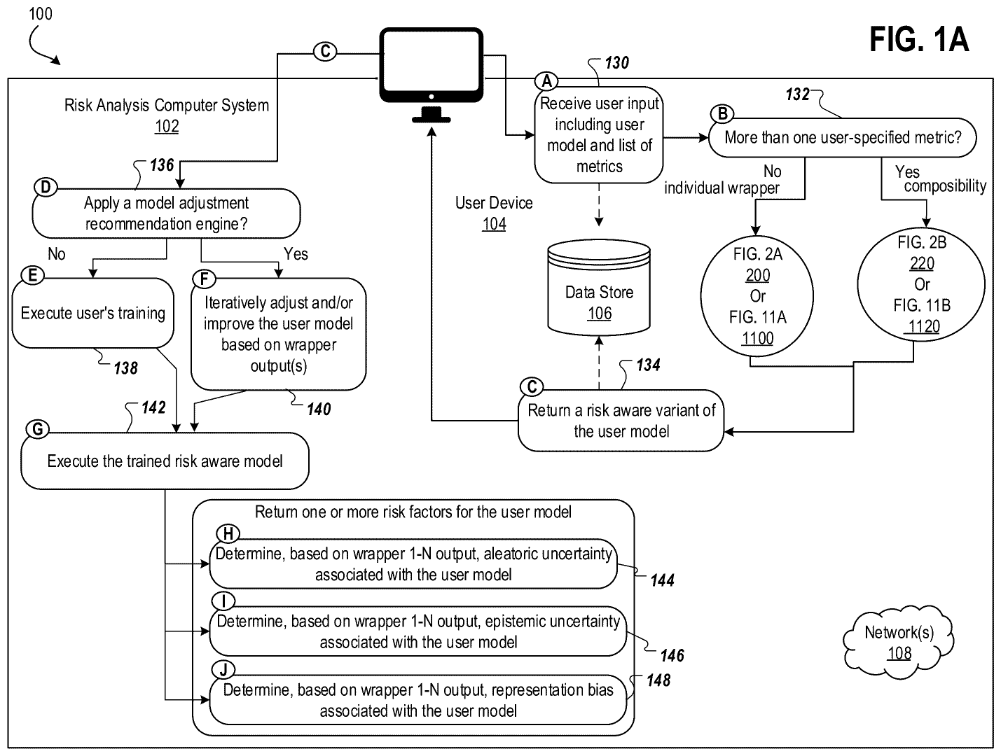

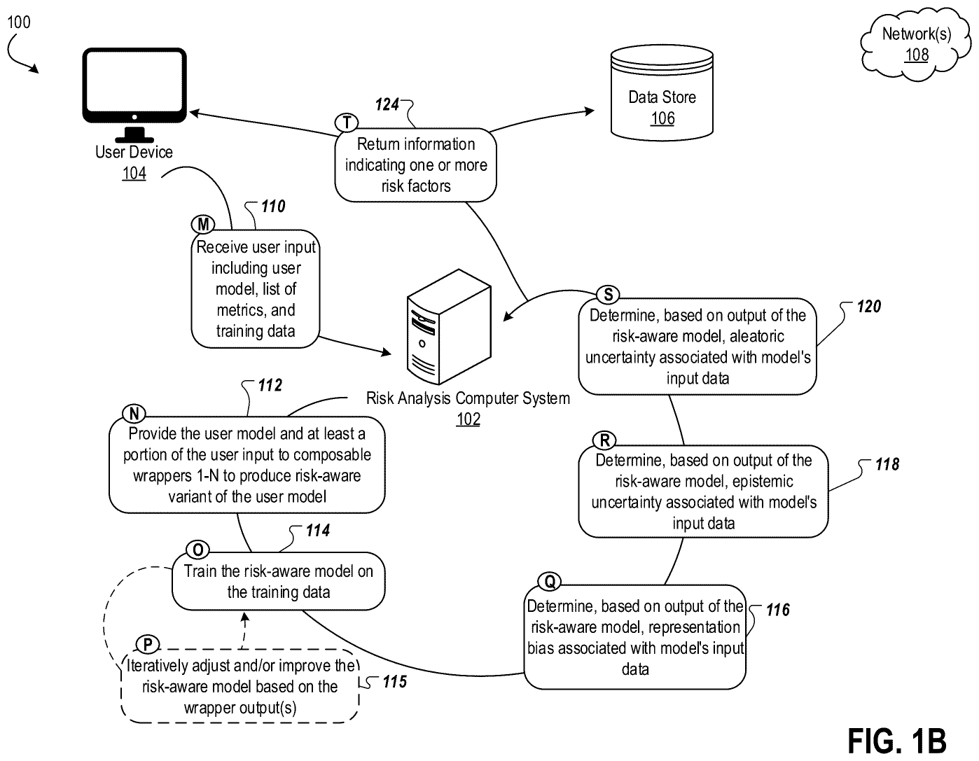

Referring to the figures, FIG. 1A is a conceptual diagram of a system 100 for performing risk assessment of a machine learning model. The system 100 can include a risk analysis computer system 102, a user device 104, and a data store 106 in communication (e.g., wired, wirelessly) via network(s) 108. In some implementations, the user device 104 and/or the data store 106 may be part of the computer system 102. Sometimes, one or more of the user device 104 and the data store 106 may be separate systems from the computer system 102 and/or remote from the computer system 102. Further discussion about the system components is provided herein with respect to FIG. 1B.

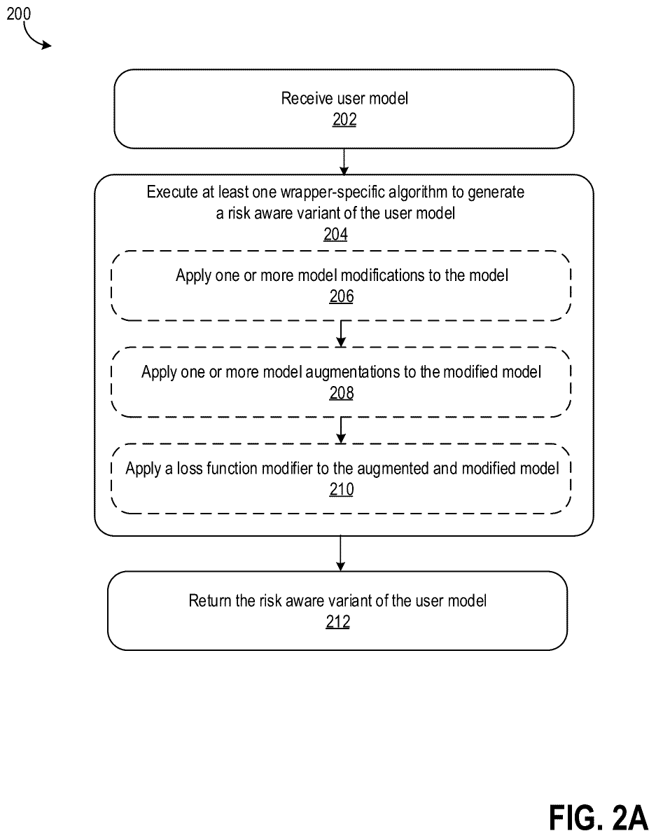

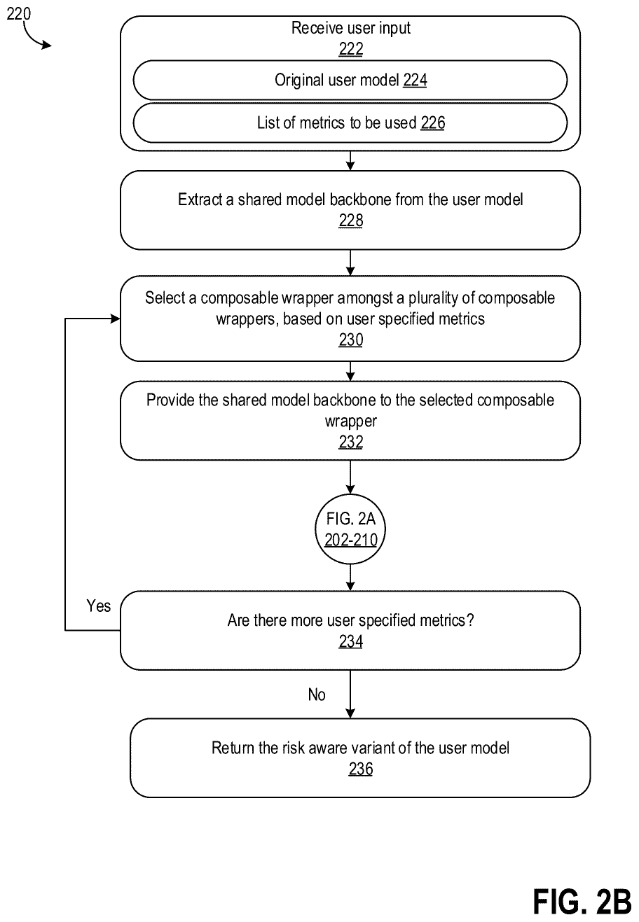

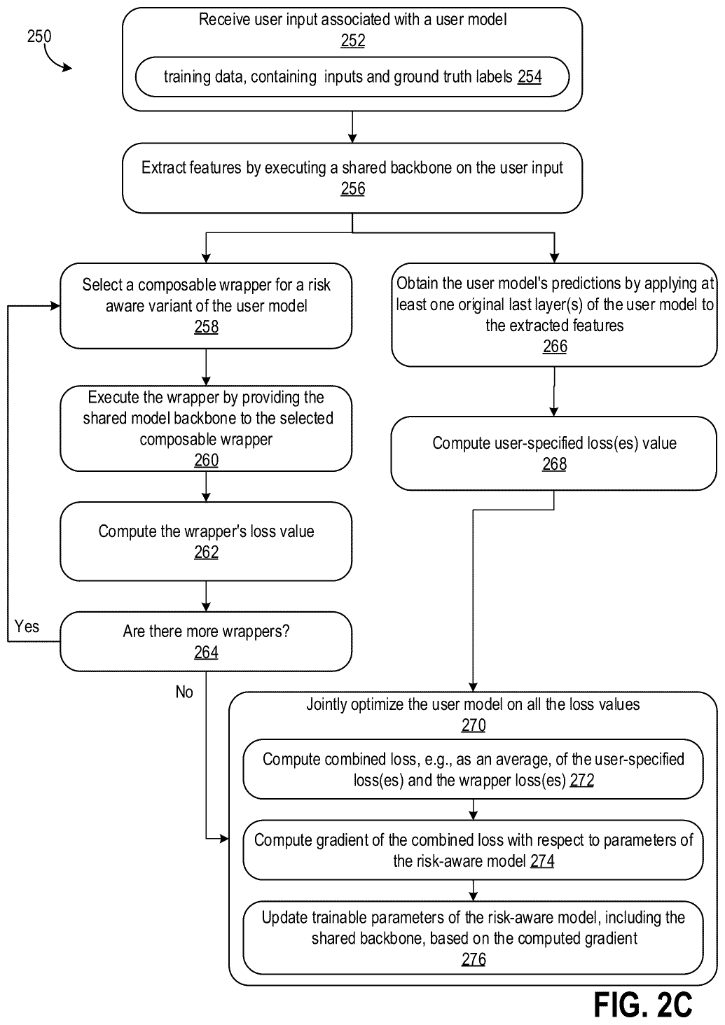

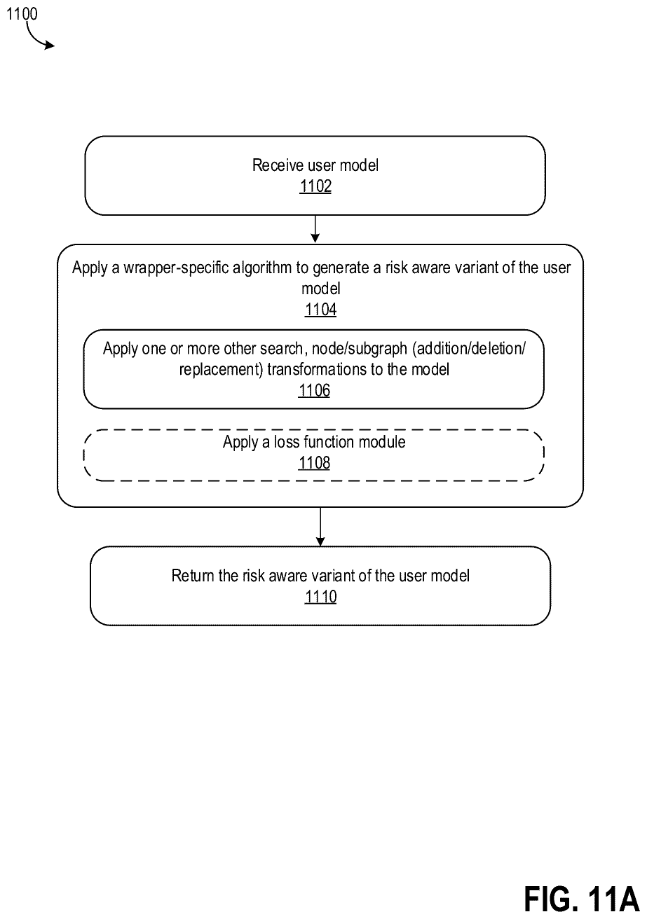

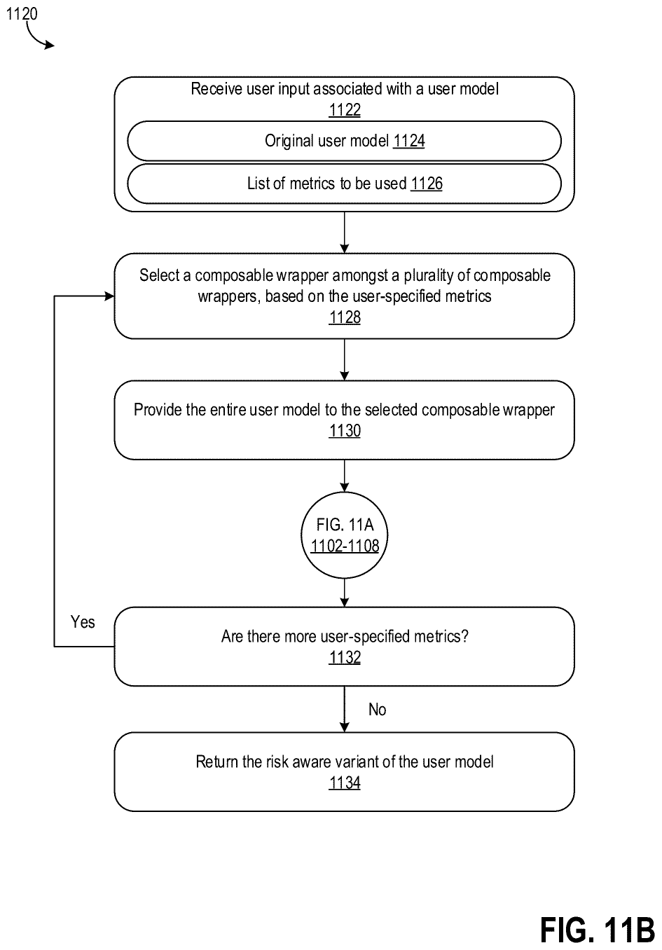

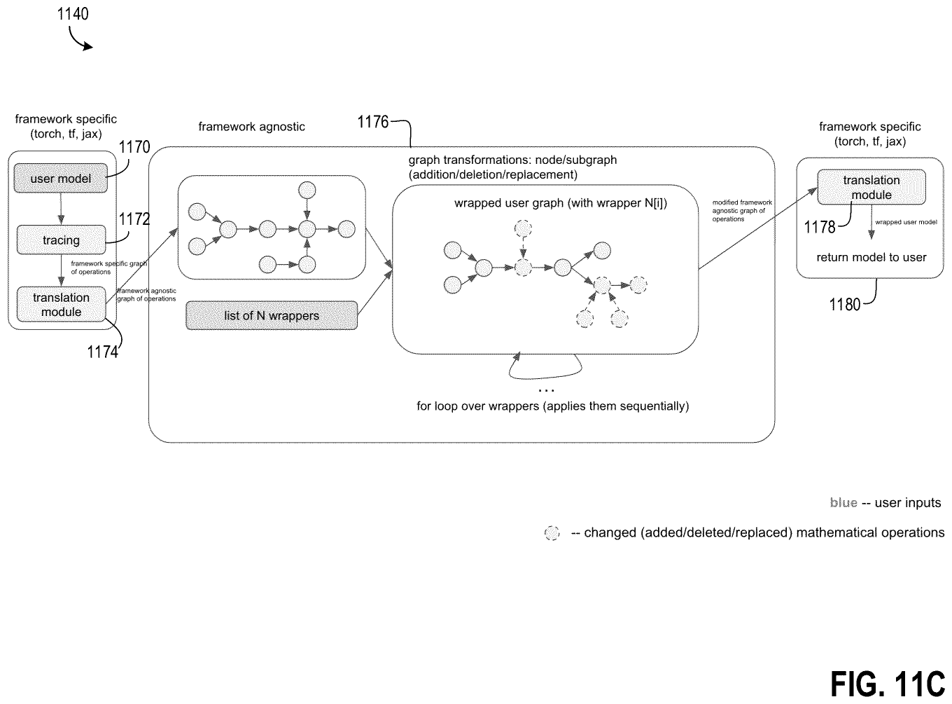

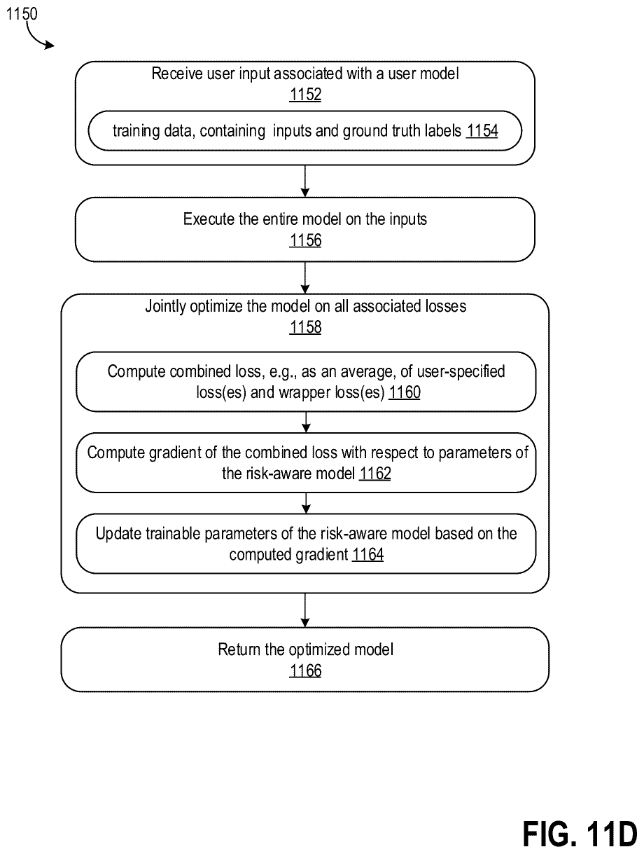

In the example system 100, user input including a user model (e.g., arbitrary model that is not previously seen) and list of metrics can be received at the user device 104 (block A, 130). The user input can be provided to the data store 106 for storage. The user input may also be processed, such as by the computer system 102, to determine whether more than one user-specified metric is provided in the user input (block B, 132). If only one user-specified metric is provided, the computer system 102 can proceed to process 200 in FIG. 2A, in which an individual wrapper(s) is applied to the user input. If more than one user-specified metric is provided (block B, 132), the computer system 102 proceeds to process 220 in FIG. 2B, in which composability techniques are used, as described further below. Additionally, or alternatively, if only one user-specified metric is provided, the computer system 102 can proceed to process 1100 in FIG. 11A, and if more than one user-specified metric is provided, the computer system 102 can proceed to process 1120 in FIG. 11B.

After the process 200 is performed in FIG. 2A ,or the process 220 is performed in FIG. 2B, a risk aware variant of the user model may be returned (block C, 134). The risk aware variant may be stored in the data store 106. The risk aware variant may be provided to the user device 104 and/or can be transmitted to the computer system 102.

The computer system 102 may determine whether to apply a model adjustment recommendation engine in block D (136). If model adjustments do not need to be made, the computer system 102 can execute the associated user's training on the user model (block E, 138). This training may be similar to training that is performed before the model is wrapped in the processes 200 and 220 of FIGS. 2A and 2B, respectively.

If, on the other hand, the computer system 102 determines that adjustments should be made, the computer system 102 can iteratively adjust and/or improve the user model based on wrapper output(s) (block B, 140). Once either the user training and/or the iterative adjustments are complete, the computer system 102 can execute the trained risk aware model in block G (142).

Executing the trained risk aware model may cause the computer system 102 to return one or more risk factors for the user model, such as determining, based on wrapper 1-N output, aleatoric uncertainty associated with the user model (block H, 144), determining, based on the wrapper 1-N output, epistemic uncertainty associated with the user model (block I, 146), and/or determining, based on the wrapper 1-N output, representation bias associated with the user model (block J, 148). The risk factors may be returned to the user device 104 and/or stored in the data store 106 in association with the user model and/or the risk aware variant of the user model.

FIG. 1B is another conceptual diagram of the system 100 for performing risk assessment of a machine learning model. The system 100 again includes a risk analysis computer system 102, a user device 104, and a data store 106 in communication (e.g., wired, wirelessly) via network(s) 108. The risk analysis computer system 102 can be configured to perform the risk assessment described herein on one or more original models. The original models can be stored in the data store 106 and/or provided by the user device 104 to the computer system 102 for execution of the risk assessment. In some implementations, the computer system 102 can be a library that is configured to automate creation of uncertainty-aware machine learning models. The library can be a PYTHON library. One or more other types of libraries may be used. The computer system 102 can be any type of computing device, system, cloud-based system, and/or network of computing devices/systems.

The user device 104 can be any type of computing device, mobile device, computer, laptop, tablet, mobile phone, smartphone, or other computing system. The user device 104 can be configured to provide information about the original models for which the risk assessment is requested to be performed. The user device 104 can be controlled by a user who developed or otherwise maintains control over the original model(s).

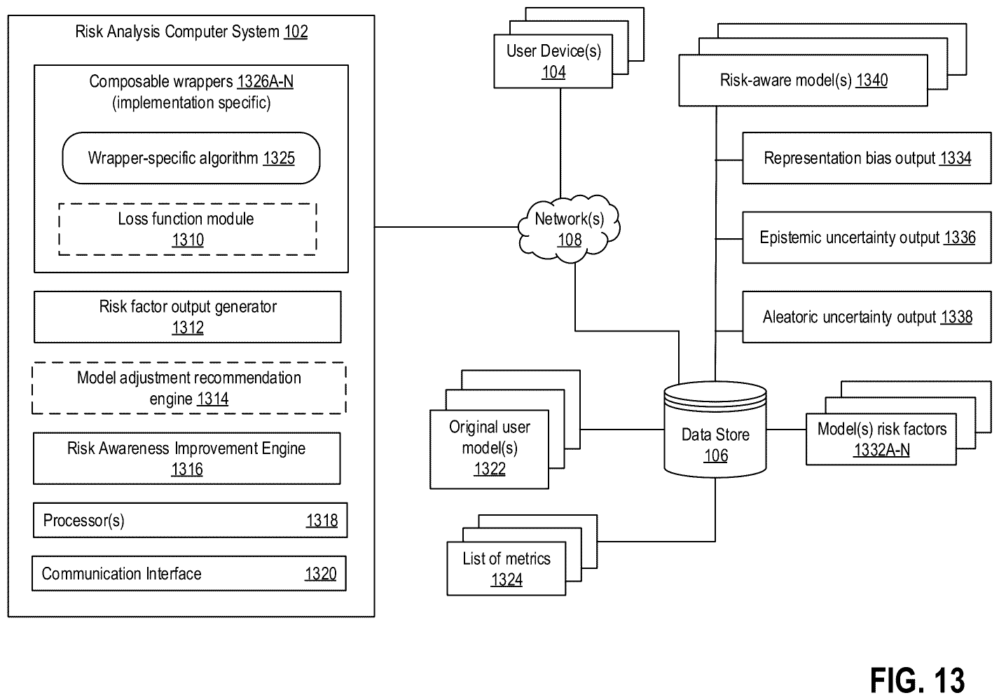

The data store 106 can be any type of database, data storage, memory, and/or cloud-based storage system configured to maintain and securely store data and information used to perform the disclosed technology. A further discussion about the system 100 components is provided with respect to FIG. 13 below.

The risk analysis computer system 102 can receive user input from the user device 104, including an original user model (e.g., the model can have an arbitrary architecture) and a list of metrics (block M, 110). The computer system 102 can utilize multiple risk metrics included in the list of metrics to create robust ways of estimating risk in the received user model (e.g., by combining multiple metrics together into a single metric, or alternatively by capturing different measures of risk independently).

In block N (112), the computer system 102, based at least on the user-specified list of metrics, can select one or more composable wrapper(s) and execute them on the user model to produce a risk-aware variant of the user model. The computer system 102 can generate a shared backbone from the user model and execute it on the user input to extract features for the downstream wrappers.

The computer system 102 can provide the extracted features and at least a portion of the user input to one or more composable wrappers 1-N (block N, 112). The computer system 102 can implement a composability algorithm to achieve the above described techniques. The shared feature extractor can be leveraged as the common backbone of all metrics, and all model modifications to the model can be incorporated into the feature extractor. Then, new model augmentations can be applied in series or in parallel, depending on use case (e.g., a metric can be ensembled in series to average the metric over multiple joint trials, or ensembling can be applied in parallel to estimate an independent measure of risk).

In block O (114), the computer system 102, can train the risk-aware model on the user provided data jointly optimizing relevant loss functions and computing a gradient of each loss with regard to the weights of the shared backbone and other trainable parameters added by each wrapper and stepping into the direction of an accumulated gradient. Further details about transforming the user model are provided below with respect to the process 200 of FIGS. 2A and 2B.

Still referring to FIG. 1B, the computer system 102 can, optionally, iteratively adjust and/or improve the user model based, at least in part, on any one or more of the wrapper output(s) (block P, 115).

The disclosed technology can be used to assess one or more different types or categories of risk, which can capture different forms of risk metrics. Such categories of risk can include, but are not limited to, representation bias (also referred to as vacuitic uncertainty), aleatoric uncertainty, and/or epistemic uncertainty. Accordingly, the computer system 102 can determine output of the trained risk-aware model, representation bias associated with the user model (block Q, 116). Additionally, or alternatively, the computer system 102 can determine, based on the wrapper 1-N output, epistemic uncertainty associated with the user model (block R, 118). Additionally, or alternatively, the computer system 102 can determine, based on the wrapper 1-N output, aleatoric uncertainty associated with the model (block S, 120). The computer system 102 can ensemble multiple metrics, and/or obtain different types of uncertainty estimates.

It shall be appreciated that blocks Q, R, and S (116, 118, and 120 respectively) can be performed in any order, simultaneously (in parallel), in series, and/or within one or more threshold periods of time from each other. In some implementations, at least one but not all of the blocks Q, R, and S (116, 118, and 120) may be performed (which can depend, at least in part, based on the list of metrics received as part of the user input in block M, 110).

In block Q (116), the representation bias of a dataset/the user model can uncover imbalance in a feature space of the dataset and may capture whether one or more combinations of features are more prevalent than others. This can be different from label imbalance, which may only capture distributional imbalance in the labels. In illustrative automobile driving datasets, for example, a combination of straight roads, sunlight, and no traffic can be higher than other feature combinations, indicating that these samples may be overrepresented. Similar overrepresentation can be shown for datasets involving facial detection, medical scans, and/or clinical trials. Transforming the user model into its risk aware variant can be achieved, for example, by modifying the model's computational graph directly (as opposed to modifying code that generated the computational graph). Accordingly, the disclosed technology leverages the fact that it is tractable to write an algorithm that transforms the computational graph (at least because the graph has only a small set of defined semantics that can be modeled) but it is not tractable to create an algorithm that re-writes e.g., python code, directly (which may have, for example, rich syntax).

Representation bias, which can also be referred to as vacuitic uncertainty, captures whether certain combinations of features are more prevalent than others. Traditionally, uncovering feature representation bias can be a computationally expensive process as these features may be (1) often unlabeled and/or (2) high-dimensional (e.g., images, videos, language, etc.). Feature representation bias, however, can be estimated by learning density distribution of the data. Thus, the computer system 102 can estimate densities in a feature space corresponding to the data/the user model in block Q (116) to identify feature representation bias. For high-dimensional feature spaces, the computer system 102 can estimate a low-dimensional embedding using a variational autoencoder and/or by using features from a penultimate layer of the model. Bias can also be estimated as an imbalance between parts of the density space estimated either discretely (e.g., using a discretely-binned histogram) and/or continuously (e.g., using a kernel distribution).

Epistemic uncertainty measures uncertainty in the model's predictive process. This can capture scenarios such as examples that may be challenging to learn, examples whose features may be underrepresented, and/or out-of-distribution data (block R, 118). A unified approach for a variety of epistemic uncertainty methods can be provided by the computer system 102, ranging from Bayesian neural networks, ensembling, and/or reconstruction-based approaches.

A Bayesian neural network, for example, can be approximated by stochastically sampling, during inference, and/or from a neural network with probabilistic layers. Adding dropout layers to a model can be used to capture epistemic uncertainty. To calculate the uncertainty, T forward passes can be run, which may, in some implementations, be equivalent to Monte Carlo sampling. Computing first and second moments from the T stochastic samples can yield a prediction and uncertainty estimate, respectively.

An ensemble of N models, each a randomly initialized stochastic sample, can present a gold-standard approach to accurately estimate epistemic uncertainty. To reduce cost of training ensembles, the computer system 102 can automate construction and management of a training loop for all members of the ensemble, thereby parallelizing their computation.

Variational autoencoders (VAEs) can be used to learn a robust, low-dimensional representation of latent space. They can be used as a method of estimating epistemic uncertainty by using reconstruction loss MSE(\hat{x}, x). In cases of out-of-distribution data, such as samples that can be hard to learn, or underrepresented samples, the VAE can have high reconstruction loss, at least because mapping to the latent space may be less accurate. Conversely, when the model is more familiar with features being fed in, or the data is in distribution, the latent space mapping can be robust and reconstruction loss can be low. To construct the VAE for any given model, the computer system 102 can use a feature extractor described herein as an encoder. The computer system can also reverse the feature extractor automatically, when possible, to create a decoder.

In block S (120), aleatoric uncertainty can capture noise in the data, including but not limited to mislabeled data points, ambiguous labels, classes with low separation, etc. Aleatoric uncertainty can be modeled using mean and variance estimation (MVE). In a regression case, for example, outputs of the models feature extractor can be passed to another layer (or multiple other layers) that can predict a standard deviation of the output. Training can be performed using negative log likelihood (NLL), and predicted variance can be used as an estimate of the aleatoric uncertainty. A modification can be applied to the algorithm to generalize it to a classification case, as shown in illustrative Algorithm 1.

Algorithm 1
Algorithm 1 Aleatoric Uncertainty in Classification

| | | |
|---|---|---|
| 1: | μ, σ ← fw(x) | [symbol] Inference |

| | | |
|---|---|---|
| 2: | for i ∈ 1..T do | [symbol] Stochastic logits |

| 3: | \tilde{z} ← μ + σ × ϵ~ [symbol] (0, 1) |
|---|---|
| 4: | end for |

| | | |
|---|---|---|
| 5: | $\tilde{z} ← \frac{1}{N} \times {\sum }_{s = 1}^{T} \tilde{z}$ | [symbol] Average logit |

| | | |
|---|---|---|
| 6: | $\hat{y} ← \frac{exp ( \tilde{z} )}{{\sum }_{y} exp ( {\tilde{z}}_{y} )}$ | [symbol] Softmax probability |

| | | |
|---|---|---|
| 7: | [symbol] (x, y) ← −Σᵢ yⱼ log pⱼ | [symbol] Cross entropy loss |

The classification logits in Algorithm 1 can be drawn from a normal distribution and they can be stochastically sampled from using a re-parametrization technique(s). For example, stochastic samples can be averaged and back-propagated using cross entropy loss through those logits and their inferred uncertainties.

The computer system 102 can return information indicating one or more risk factors associated with the user model and/or associated with input of the risk-aware model (block T, 124). The information can indicate one or more risk factors corresponding to representation bias, epistemic uncertainty, and/or aleatoric uncertainty. One or more other risk assessments can be performed and results can be returned in the information. In some implementations, the computer system 102 can generate an overall risk factor and/or risk assessment for the user model based on a combination of the output from representation bias, epistemic uncertainty, and/or aleatoric uncertainty. Sometimes the computer system 102 can generate and return a singular value indicating overall risk and/or uncertainty of the user model.

Returning the information in block T (124) may include generating uncertainty estimates that match shape and/or format of an original value the model would return. For example, if the model typically outputs 10 numeric values, then the wrapped, risk-aware variant of the model can output the original 10 numeric values in addition to 10 uncertainty estimates, one for each value. Similarly, if the model originally would output an image (pixels), then the wrapped, risk-aware variant of the model can output an uncertainty estimate for each pixel plus the original image output. In some implementations, the computer system 102 may add and/or average all of the returned values to generate a singular value indicating risk. Matching the original shape and format of the output allows relevant users to understand exactly what parts of the model output are higher-risk (which is part of how the users get “explainability” from the disclosed techniques). In some cases, such as classification, the model may simply have one output (e.g., yes or no), which can cause the computer system 102 to generate a singular value indicating overall risk for that model. However, the generated and returned information may be for a specific output so that risk/uncertainty information can be provided every time that output is provided by the model (which further helps with “explainability” at least because the relevant users may see when the output becomes higher risk).

The information can be transmitted to the user device 104. The user device 104 can present at least a portion of the information in one or more graphical user interface (GUI) displays at the user device 104. Information can be presented in the GUI, such as one or more risk factors that are determined using the disclosed techniques. In some implementations, presenting/displaying the risk factor(s) or other information in the GUI displays can be a result of different interfaces (e.g., PyTorch, Tensorflow, Pyton, etc.) that cause the information to present itself at the respective displays.

A relevant user may then review the presented information and determine how to improve/adjust the user model based on the one or more risk factors. In some implementations, a computer system and/or computer program can assess the information and determine how to improve/adjust the user model based on the risk factors (and/or generate recommendations for improving/adjusting the user model). In yet some implementations, the relevant user and the computer system/program may determine improvements and/or adjust the user model in conjunction. The information can also be transmitted to the data store 106 for storage. The information can then be retrieved at a later time, by the computer system 102 for further processing, analysis, and/or model improvement, and/or by the user device 104 for presentation and/or model improvement.

FIG. 2A is a flowchart of a process 200 for applying an implementation of an individual wrapper to a machine learning model during an initialization stage. The disclosed technology can provide a unified model-agnostic framework for risk estimation, which allows for seamless and efficient integration of uncertainty estimates to existing models in a couple lines of code. The disclosed technology may open new avenues for greater reproducibility and benchmarking of risk and uncertainty estimation methods.

The process 200 can be performed by the risk analysis computer system 102. The process 200 can also be performed by one or more other computing systems, devices, computers, networks, cloud-based systems, and/or cloud-based services, including but not limited to the user device 104. For illustrative purposes, the process 200 is described from the perspective of a computer system.

Once a model is wrapped, a risk assessment may be performed continuously as the model is being used. Therefore, whenever the model is called, the disclosed techniques can be used to return a risk aware variant of the user model and generate output indicating uncertainty values associated with the model execution. Wrapping the model may occur once (e.g., once per model architecture). If the model architecture changes, then the wrapping of the model may be re-run. The risk assessment may occur every time that the wrapped model receives an input, which can occur continuously during training (as the model continuously receives new training data as input to learn from) and/or during deployment (as the model is exposed to new input data during runtime use).

Referring to the process 200 in FIG. 2A, the computer system can receive user input in block 202. The user input can include an original user model, and the original user model can include at least a model architecture. The computer system may then execute at least one wrapper-specific algorithm to generate a risk aware variant of the user model (block 204). For example, a model modification module of the computer system may apply one or more model modifications to the model (block 206). As another optional example, a model augmentation module may apply one or more model augmentations to the modified model (block 208). As yet another optional example, a loss function module may apply a loss function modified to the augmented and/or modified model (block 210). These applications can occur as standalone wrapper operations, or multiple applications can occur in the same risk aware variant analysis.

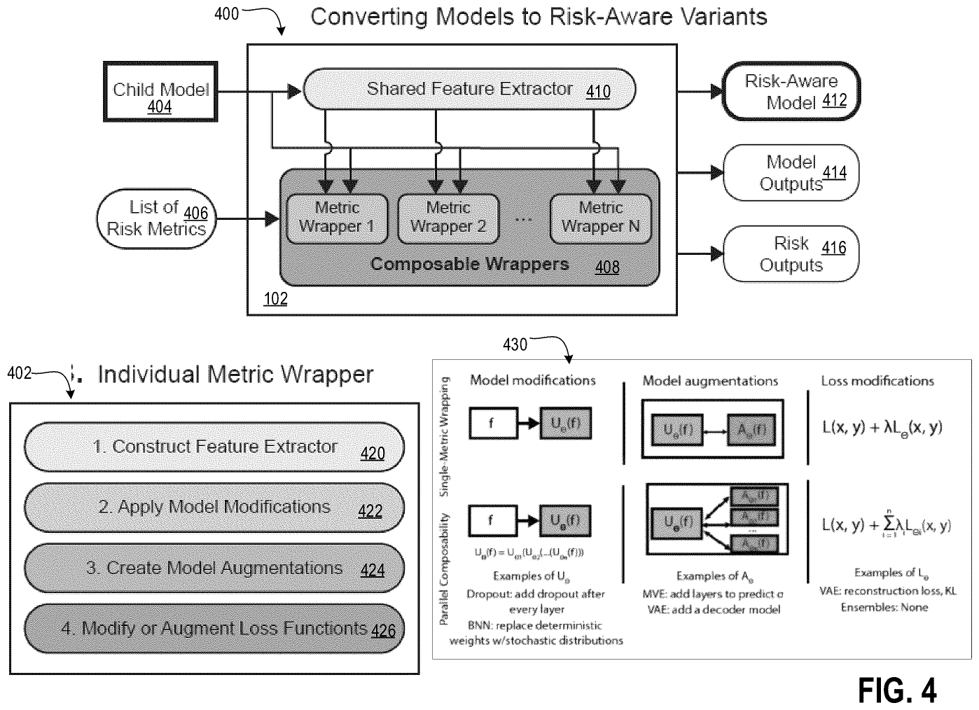

As an illustrative example of block 206, the computer system can automatically change a deterministic weight to a stochastic weight. This aspect is also at least further described with respect to FIG. 4 below. In some implementations, the computer system can optionally apply one or more other transformations, such as search, add, delete, and/or replace transformations, to the model for the specific wrapper. The search transformations can include, for example, automatically searching through the model and identifying specific instances of locations/computational operations in the model that can be transformed. Multiple criteria can be used to identify what parts of the model need to be transformed, among others, e.g., domain knowledge (understanding of NN design and optimization); requirements of a risk estimation algorithm (understanding of what transformations each specific wrapper needs to apply). For the first criterion, the fact that a model is represented as a directed acyclic graph and that a model computes the backward pass, constraints what modifications can be performed on that graph (some acute examples of clearly undesirable modifications include, e.g.,: rewiring the backward graph without changing the forward graph, using non-differentiable operations, etc.; and many other more subtle examples that fall in between). Conversely other types of modifications may be understood as reasonable to be performed.

Another criterion is based on understanding what specific transformations each wrapper is needed to apply. Accordingly, the transformations described herein can be represented as modifications of the model's computational graph without modifying actual user code that generated the model. As an illustrative example, a transformation to represent algorithmically may be an insertion of a mathematical operation in the graph representing the user model. Because the original model is received as input, the computer system can identify what mathematical operations the model computes. The computer system may narrow down possible places in the model that are fit for inserting a layer. For example, for each wrapper, a set of mathematical operations in the graph that the computer system needs to search for can be identified and if the computer system finds these operations, the computer system may insert that layer after that found operation.

To search the model, the computer system may implement a matching algorithm (e.g., in each wrapper), which knows what set(s) of operations (nodes) and/or group(s) of operations (subgraphs) for which to search. Further, because each wrapper receives the user model as input (e.g., the graph of operations), the wrapper may also be configured to know what operations are contained in the user model. Therefore, the wrapper may simply match (i.e., find) one or more subgraphs, which the model can identify and recognize, in the user model graph (e.g., subgraph matching). Sometimes the computer system may trigger additional or other model transformations. For example, additional transformations may be triggered if, inside a single wrapper, the model has already been transformed but the relevant user specifies that they desire applying another wrapper on top of the already-wrapped model (sequential composability of wrappers, which may result in output of one wrapper being fed to another wrapper etc.). Additional transformations applied in this example may be defined by the wrapper that receives the already-wrapped model. One or more additional wrappers may also be applied sequentially.

Any transformations of a user model inside a wrapper can be performed as described above in reference to searching components inside that model and inserting/deleting/replacing these components. The one or more model components can include at least one of: (i) one or more mathematical operations performed by the original model; (ii) subgraphs of the one or more mathematical operations, the subgraphs being one or more respective layers; and/or (iii) one or more groups of the subgraphs.

As an example of block 208, the computer system can add one or more layers to the model in one or more places that are specific to a particular wrapper. The computer system may automatically transform the model into its risk aware variant, by applying a wrapper to it. The wrapper can determine: (i) which layer or layers (groups of mathematical, computational operations) to add, remove, and/or replace; and (ii) what location(s) in the model to make the addition, removal, and/or replacement. An epistemic wrapper, for example, can be configured to receive a user model and transform that model by, for example, automatically adding one or more probabilistic layers (e.g., a group of mathematical operations that represent a probabilistic layer). The wrapper may also be configured to run the model T times to accurately calculate the uncertainty. By way of non-limiting examples, any of the augmentations may include adding to the model (or to the original model) groups of model components whose outputs may predict standard deviations of ground truth labels (e.g., in addition to predicting the ground truth labels themselves). Such augmentations may include adding one or more model components after each model component of a particular type (and/or by any other criteria), and/or to a group or groups of layers of the original model (e.g., subgraphs of nodes in the computational graph representing the model).

As an example of block 210, the computer system may apply a loss function to predictions from a branch (or from a layer) that inputs features from an upstream layer of the model (or from a shared feature extractor). A branch is a group of mathematical operations (e.g., layers) that some wrappers add on top of a shared feature extractor described herein. These layers may contain some wrapper-specific logic for computing a risk estimate (e.g., a wrapper that computes the epistemic risk may add a branch on top of the shared feature extractor, this branch may contain some operations that compute epistemic risk). In some implementations, for example, where the shared feature extractor is used, the computer system may compute loss from the output of the feature extractor and also compute additional losses from the output of each individual branch. During the training stage, the risk aware model can be jointly optimized on all the losses (refer to FIG. 2C).

Subsequently, the computer system can return the risk aware variant of the user model (block 212). The risk aware variant of the user model may further be trained (as described in reference to FIG. 1A) and executed to generate and output one or more risk factors associated with the user model. For example, and as further described below, the computer system can determine representation bias, epistemic uncertainty, aleatoric uncertainty, any combination thereof, and/or other types of risk factors/categories (which can be defined by the user's list of metrics in at least some implementations). The computer system can store the risk factors and/or the risk aware variant more generally in a data store in association with the original user model (e.g., using a unique identifier/ID that corresponds to and identifies the original user model). The computer system can transmit the risk factors and/or the risk aware variant to the user device for presentation at the device to a relevant user. The computer system can also generate and return one or more recommendations for adjusting the original user model. Such recommendations can be stored in the data store and/or transmitted to the relevant user device.

FIG. 2B is a flowchart of a process 220 for applying an implementation of wrapper composability (at initialization stage) to a machine learning model, using the disclosed technology. The process 220 is further visualized in FIG. 4, described further below. As described herein, the process 220 can be used to compose different algorithms together to quantify various risk metrics efficiently, and in parallel, and demonstrate how the obtained uncertainty estimates can be used for downstream tasks, such as improving and adjusting models. This framework can also yield interpretable risk estimation results that can provide a deeper insight into decision boundaries of different types of models, such as NNs. The disclosed technology may also be expanded to data modalities, including irregular types (e.g., graphs) and temporal data (e.g., sequences), as well as various other model types and/or risk metrics. The process 220 can similarly be performed by the computer system 102, as described in reference to FIG. 2A. For illustrative purposes, the process 220 is described from the perspective of a computer system.

Referring to the process 220, the computer system receives user input in block 222. The user input may include, for example, an original user model (block 224). Sometimes, the user input can also include the model and/or weights (even before the model is trained). As a result, the disclosed techniques can be used at any stage of model development (e.g., data preparation, training, while the model is being used, when the model is fine-tuned). The user input can include a list of metrics to be used in risk assessments of the user model (block 226). The user input is described herein at least with respect to block A (110) of FIG. 1B above.

The computer system can extract a shared model backbone from the user model in block 228. This is further described at least with respect to FIG. 4 below. Using the shared model backbone, the computer system may extract features from at least a portion of the user input. This is also further described at least with respect to FIG. 4 below.

The computer system can select a composable wrapper amongst a plurality of composable wrappers for one or more computational operations of the original user model and based on the user-specified metrics in the user input (block 230). Sometimes the computer system can select one or more composable wrappers. Each of the selected wrapper(s) may modify a computational graph of the model, the computational graph containing one or more mathematical operations performed by the model. Each layer of the model may contain one or more mathematical operations. By having the wrappers operate on a level of individual mathematical operations, the computer system can perform more granular, less constrained modifications to the model. The disclosed technology allows for automatically transforming the computational graph of the model, as specified by a particular wrapper, to perform the risk assessments described herein. As described further below, the disclosed technology can be used not only to change/transform the user model, but also to increase or otherwise improve model precision.

In some implementations, the computer system may automatically adjust what parts of the model a particular wrapper is applied to (e.g., a single operation in a model, the entire model, and/or anything in between) depending on one or more constraints (e.g., accuracy, where some parts of the model may be more sensitive to accuracy loss than others, desired inference speed of the model, and/or a memory constraint). Sometimes a minimum threshold of computational operations of the model can be assessed. As an illustrative example, 75% of the original user model can be wrapped in block 216, which means 75% of all the computational operations of the model can be wrapped. Wrapping and assessing 75% of the model computational operations can be advantageous when performing risk assessments for robust and large language models. Wrapping such types of models may require ample computer processing resources. However, wrapping and assessing 75% of the model computational operations can be sufficient to ensure that the model is validated, working, and accurately assessed for overall risk. This threshold for the percent of computational operations to be wrapped is not limited to that specific number, and can fall anywhere within the 0% to 100% range (e.g., 5%, 95%) (block 216). This threshold can be, for example, 5% or more of layers wrapped. One or more other threshold ranges and/or quantity of model computational operations can be wrapped in block 216. As a further non-limiting example, approximately a range of about 5% to about 75% (in lieu of 0% to 100%, which is also an option, as indicated) of the computational operations of a model can be wrapped and assessed in the process 200. This range can fall anywhere within that range (or within the 0% to 100% range), such as approximately in a range of about 10% to about 75%, approximately in a range of about 10% to about 70%, and others. Further, the computational operations to which the wrapper(s) is applied can be greater than 75%. For example, approximately a range of about 75% to about 100% of the computational operations of the model can be wrapped and assessed in the process 200A wrapper applies graph modifications until all the computational operations have been assessed and/or the minimum threshold of computational operations have been assessed.

In block 232, the computer system can provide the shared model backbone to the selected composable wrapper(s). In some implementations, the computer system may apply the plurality of composable wrappers sequentially to the original user model. The computer system may represent the original user model in a graph of mathematical/computational operations that the model performs. Then, each wrapper may modify the entire graph.

Once the shared model backbone is provided to the wrapper(s) in block 232, the computer system can proceed to perform blocks 202-210 in the process 200 of FIG. 2A. Then the computer system can return to the process 220 and determine whether there are more user-specified metrics in block 234. For example, after applying a wrapper, if there are more user-specified metrics, the computer system can return to block 230 and continue through the process 220 and apply an additional wrapper (at least because a metric represents the type of risk to be assessed, a wrapper can be selected based on that user-specified metric). If, on the other hand, there are no more user-specified metrics, the computer system can proceed to return the risk aware variant of the user model (block 236), as described herein.

FIG. 2C is a flowchart 250 of an implementation of wrapper composability (during training stage), using the disclosed technology. The process 250 can similarly be performed by the computer system 102, as described in reference to FIG. 2A. For illustrative purposes, the process 250 is described from the perspective of a computer system.

In comparison to the processes 200 in FIG. 2A and 220 in FIG. 2B, the process 250 in FIG. 2C can be performed at a different time (e.g., a training stage instead of an initialization stage). As a result, the processes can receive different user inputs. At the initialization stage, loss function may not be computed and/or features may not be extracted to feed to one or more wrappers. Instead, during the initialization stage, modifications may be made to the model without feeding inputs to the model. During the training stage, the model may be run, which may require different inputs from the user, such as a training dataset.

Referring to the process 250 in FIG. 2C, the computer system can receive user input associated with a user model in block 252. The user input may include, for example, training data, containing inputs, and/or ground truth labels (block 254).

The computer system may extract features by executing a shared backbone on the user input (block 256). The computer system can then proceed to perform block 258 or block 266.

In block 258, the computer system can select a composable wrapper for a risk aware variant of the user model. The computer system executes the wrapper by providing the shared model backbone to the selected composable wrapper (block 260). The computer system may then compute the loss value of the wrapper, based, at least in part, on execution of the wrapper (block 262). The computer system may then determine whether there are more wrappers to execute in block 264. If there are more wrappers to execute, the computer system can return to block 258 and proceed through blocks 258-262 for each remaining wrapper. If there are no more wrappers to execute, the computer system proceeds to block 270, described further below.

The computer system can proceed to block 266 and 258. In block 266, the computer system can obtain the predictions of the user model, for example by applying at least one of the original last layers of the user model to the extracted features from block 256. Then the computer system can compute one or more user-specified loss values in block 268 and proceed to block 270.

In block 270, the computer system can jointly optimize the user model on all of the loss values (determined in blocks 262 and/or 268). For example, the computer system can compute a combined loss as an average of the user-specified loss(es) and/or the wrapper loss(es) (block 272). As another example, the computer system can compute gradient of the combined loss with regard to risk-aware model parameters (block 274). As yet another example, the computer system can update trainable parameters of the risk-aware model, including the shared backbone, based on the computed gradient (block 276).

Sometimes the computer system can generate and/or execute one or more adjustments to the original user model based, at least in part, on jointly optimizing the user model. Example adjustments may include removing noisy and/or incorrectly labeled data from a training dataset so that the model can be retrained with the cleaned training dataset. Threshold value(s) may be added to parts of the model so that the model continues with its procedure if the resulting uncertainty is less than the threshold value(s). Parts of the model (such as subgraphs of nodes in the computational graph) that lead to uncertain outputs may additionally or alternatively be algorithmically modified to reduce uncertainty of such outputs. The adjustments may include, for example, modifying these subgraphs to account for uncertainty. The computer system can then proceed to block 238. Further discussion about generating and/or executing the adjustments to the model are described below.

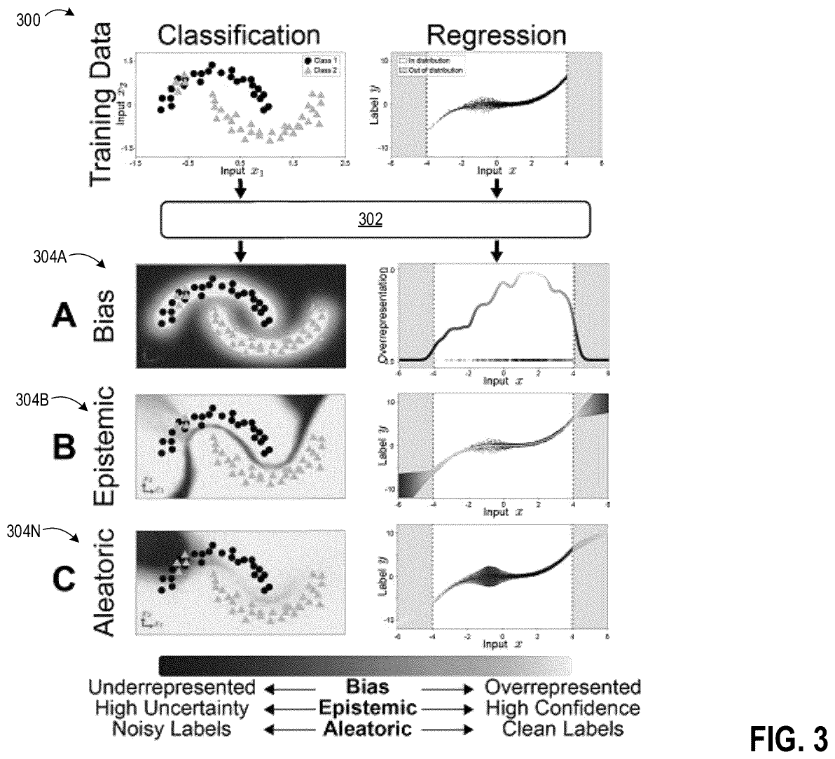

FIG. 3 is a conceptual diagram for performing risk assessment for machine learning. The risk assessment can be a risk estimation, which may be required for NNs to be deployed in safety-critical domains. Current methods of uncertainty estimation may be ad-hoc, narrow, and/or computationally expensive. Moreover, the current methods may require changes to be made to each NN or other model on a case-by-case basis, which further increases costs for implementation and use. The disclosed risk assessment, on the other hand, can provide a unified framework to estimate uncertainty that plugs directly into training model pipelines and does not require case-by-case adaptations. The disclosed risk assessment is a principled, model-agnostic framework for quantifying various forms of risk for arbitrary NNs.

The risk assessment described herein can be performed by any computing system, such as the risk analysis computer system 102 described in reference to FIG. 1B. For illustrative purposes, the risk assessment of FIG. 3 is described in reference to a computer system more generally as opposed to a specific, illustrated computer system, though certainly such specific, illustrated computer systems can be used in conjunction with the risk assessment of FIG. 3.

The computer system can receive a dataset 300 and process the dataset 300 using risk-aware neural network wrapping techniques described herein (block 302). Output of the original user model 300 can be deterministic, thus lacking notions of risk or trust in a system. Using the disclosed technology, the computer system may determine a risk estimate alongside predictions of ground truth labels 304A, 304B, 304N.

Output from wrapping wrapped model can include information about one or more different types of risk, including but not limited to representation bias 304A (e.g., under/over represented parts of the data), epistemic (e.g., model), uncertainty 304B (e.g., uncertainty in the model's predictive process), and/or aleatoric uncertainty 304N (e.g., label noise, such as incorrect labels). Each sample in the classification dataset 300 can contain (x1, x2) coordinates of a point and a ground truth class of this datapoint. Each sample in the regression dataset 300 can contain x coordinate and its ground truth label y. The computer system can convert existing models into their risk-aware variants 302 (e.g., by applying wrappers), the resulting models are capable of identifying multiple forms of risk. Outputs of a trained model are visualized alongside the multiple estimated forms of risk. FIG. 304A illustrates estimated bias, an amount of underrepresentation as compared to overrepresentation, on a sliding scale, for both the classification and the regression datasets. FIG. 304B illustrates estimated epistemic uncertainty, an amount of high uncertainty as compared to high confidence, on a sliding scale, for both the classification and the regression datasets. FIG. 304N illustrates estimated aleatoric uncertainty, an amount of noisy labels as compared to clean labels, on a sliding scale, for both the classification and the regression datasets. The wrapping in block 302 can unify one or more algorithms for quantifying one or more of the risks 304A-N by converting the existing models into risk-aware variants, capable of identifying risks efficiently during training and deployment.

FIG. 4 is a conceptual diagram of a process 400 for applying an implementation of wrapper composability (at initialization stage). The system architecture 400 provides another view of composability during an initialization stage of the disclosed techniques, as described in reference to the processes 200 and 220 of FIGS. 2A and 2B, respectively. The system architecture 400 may be used to extract a portion of a model, such as a feature extractor.

The system architecture 400 can include the computer system 102, which may receive a child model 404 and a list 406 of one or more risk metrics. A risk metric is a string containing a name of a form of risk to be measured (e.g., “epistemic”) and may correspond to multiple wrappers. Actual logic of what modifications to perform are contained in individual wrappers, metrics map to the wrappers, and the wrappers may be invoked on a user model. The invoked wrappers can perform actual modifications to the user model. The risk metrics are described further in reference to a list of risk metrics 1324 in FIG. 13.

The computer system 102 can convert an arbitrary NN model 404 into its risk-aware variants by wrapping the model with one or more composable wrappers 408. Determining which wrappers to use can be based, at least in part, on the risk metrics identified in the list 406. Using the wrappers 1-N, the computer system 102 can simultaneously predict both ground truth labels 414 and risk output(s) 416. As a result of using the disclosed system architecture 400, the computer system 102 can convert the child model 404 into a risk-aware model 412.

As described herein, each risk metric can form a basis of an individual wrapper (which may also be described as a metric wrapper) 402 (e.g., any of the metric wrappers 1-N). The individual metric wrapper 402 can be constructed through metric-specific modifications to an architecture of the child model 404 and loss function, as described herein.

While risk estimation algorithms can take a variety of forms and may be developed in ad hoc settings, the computer system 102 can provide a unified algorithm building Φ_{θ} to wrap an arbitrary NN model or other machine learning model (e.g., the child model 404). One or more operations can be performed using the individual metric wrapper 402.

For example, a feature extractor can be constructed (block 420). The shared feature extractor 410, which can be defined as the model 404 until its last layer, can be leveraged as a shared backbone by multiple wrappers 1-N at once to predict multiple compositions of risk. This may result in a fast, efficient method of reusing the main body of the model 404, rather than training multiple models and risk estimation methods from scratch.

Modifications can then be made to the existing model 404 to capture uncertainty (block 422). For example, the modifications made by a wrapper can include modifying one or more weights (e.g., every weight, in some illustrative implementations) in the model 404 to be drawn from a distribution (e.g., to convert user's model to a Bayesian neural network). As another example, the model 404 can be modified by adding one or more stochastic dropout layers.

Model augmentations can be made and/or additional models can be created (block 424). The augmentations can include extra layers and/or copies of the model 404. Depending on the risk metric(s) being assessed, the computer system 102 can add new layers (e.g., to predict standard deviation sigma, of ground truth labels, in addition to predicting the ground truth labels themselves) or extra model copies when ensembling. These may not be modifications to the shared feature extractor itself 410 at least because they are not part of the feature extractor, rather they are branches on top of it, and contain logic for computing a form of risk for a particular wrapper.

Loss functions can be modified and/or augmented (block 426). The loss function can be modified to capture any remaining metric-specific changes that may need to be made. This can include, for example, combining a user-specified loss function with a metric-specific loss (e.g., KL-divergence, negative log-likelihood, etc). Any such modifications can be integrated together into a custom metric-specific forward pass, then the computer system 102 can train step to capture variations in forward passes of data through the model 404 during training and/or inference.

As shown by illustrative example 430, the disclosed technology can compose multiple methods of uncertainty to create robust uncertainty estimates. Single metric wrapping can be performed with model modifications, model augmentations, and/or loss modifications, as described above. Additionally, or alternatively, parallel composability can be performed with model modifications, model augmentations, and/or loss modifications described above. For example, one or more dropout layers can be added after every model layer, after any other quantity of model layers, and/or after a specific type or types of layers. Deterministic weights can also be replaced with stochastic distributions as part of the model modifications. Regarding model augmentations, one or more layers may be added and/or a decoder model can be added. Regarding loss modifications, reconstruction loss, KL, can be used. Sometimes, the disclosed technology may not use any ensembling techniques to create the robust uncertainty estimates described herein.

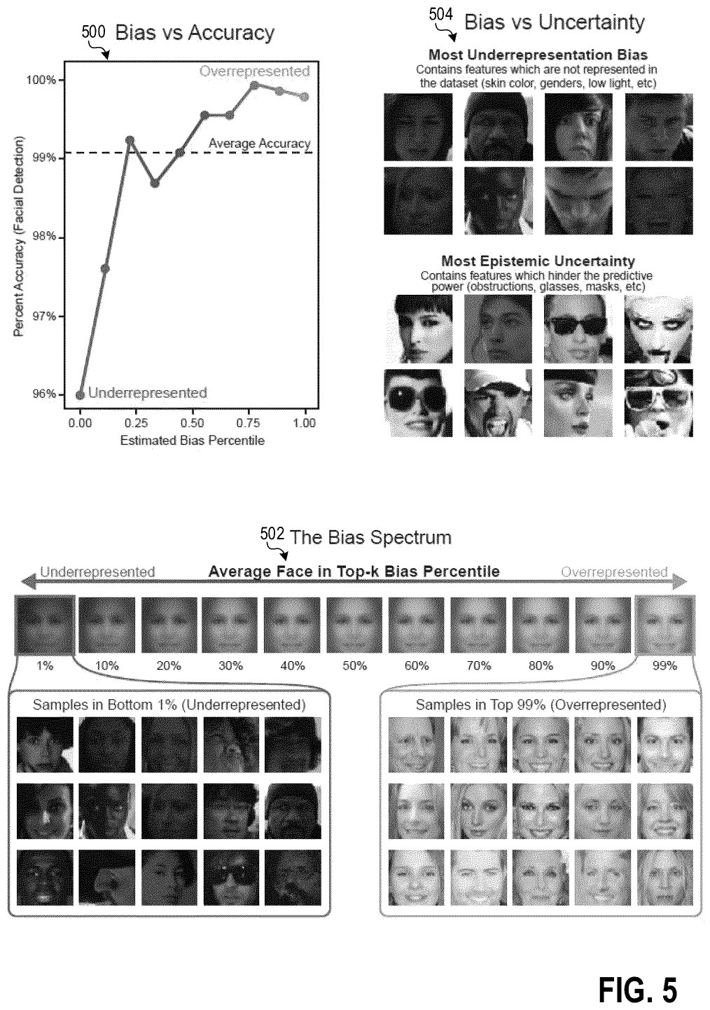

FIG. 5 illustrates example bias and epistemic uncertainty risk assessment results using the disclosed technology. An example dataset of individuals' faces can be analyzed using the disclosed technology. For example a task of a particular NN can be to detect faces from this dataset against non-face images. A bias versus accuracy graph 500 shows under-represented and over-represented faces in an example dataset found using VAE and histogram bias wrappers that are generated and implemented using the disclosed technology.

The graph 500 quantifies an accuracy versus bias tradeoff that NNs may exhibit, where such NNs tend to perform better on overrepresented training features. As shown, the average accuracy is considered to be just over 99% (e.g., 99.081%, which can be determined by averaging all accuracies on a y-axis of the graph 500), and the underrepresentations and overrepresentations are quantified. The average accuracy provides a visual indicator. Over and under representations may be determined by the x-axis of the graph 500. Any point on a right side of the x-axis is, by-definition of the x-axis, overrepresented (and the opposite is true for a left side of the x-axis). The VAE can be used for single-shot bias and epistemic uncertainty estimation with minimal added computation cost(s).

As a percentile bias of data points in the dataset increases, skin tone gets lighter, lighting gets brighter, and hair color gets lighter. Accordingly, accuracy of these data points can increase as well, as shown by a bias spectrum 502. The spectrum 502 qualitatively inspects different percentiles of bias, ranging from underrepresentation (left of the spectrum 502) to overrepresentation (right of the spectrum). Underrepresented samples in the dataset commonly may contain darker skin tones, darker lighting, and/or faces not looking at a camera. As the percentile of bias gets higher, the dataset may be biased towards lighter skin tones, hair colors, and/or a more uniform facial direction.

Data points can also be identified as having a highest epistemic uncertainty, as shown by bias versus uncertainty data 504. The data points having the highest epistemic uncertainty may have artifacts such as sunglasses, hats, colored lighting, etc. Thus, the disclosed technology can highlight a difference between bias and epistemic estimation methods. Data points estimated to have highest epistemic uncertainty may not necessarily be only underrepresented (containing features such as faces with colored lighting, covering masks, and/or artifacts such as sunglasses and hats), but also the model may not be expressive enough to represent these data points.

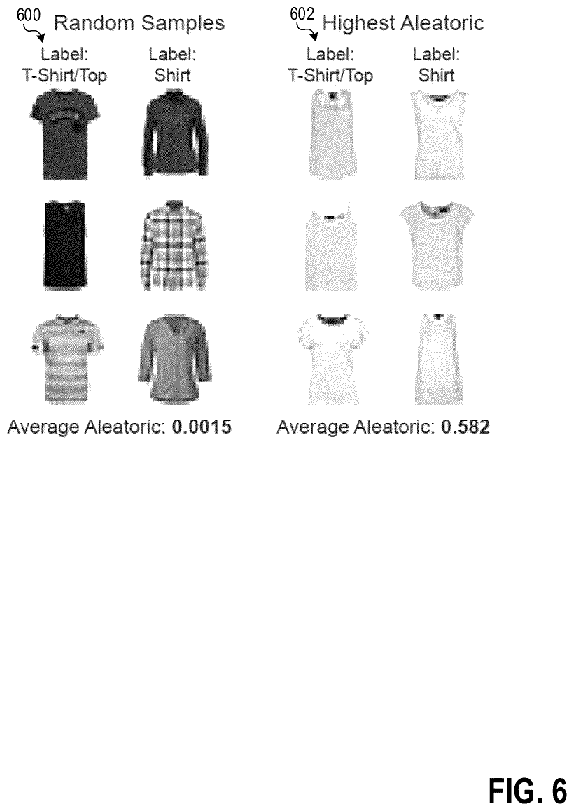

FIG. 6 illustrates example aleatoric uncertainty risk assessment results using the disclosed technology. The disclosed technology can be used, for example, to detect label noise in datasets using aleatoric uncertainty estimation. Datasets used in FIG. 6 can contain similar classes: “T-shirt/Top” and “Shirt.” The disclosed technology can identify samples in the dataset with high aleatoric uncertainty, which can include light sleeveless tops with similar necklines and with minimal visual differences. Short-sleeved shirts with round necklines may also be classified as either category. Compared to randomly selected samples from these two classes, the samples that the disclosed technology may identify as noisy can be visually indistinguishable, and may be difficult for humans (and models, in some implementations) to categorize.

As indicated above, FIG. 6 shows random image samples 600 and highest aleatoric samples 602. More particularly, the samples 600 include randomly selected samples from one or more classes of fashion datasets. These samples 600 may be visually distinguishable, and can have low aleatoric uncertainty. On the other hand, the samples 602 have a highest estimated aleatoric noise, as determined using the disclosed technology. It may not be clear what features distinguish shirts in the samples 602 from other t-shirts and/or tops, at least because they all have similar necklines, sleeve lengths, cuts, colors, etc.

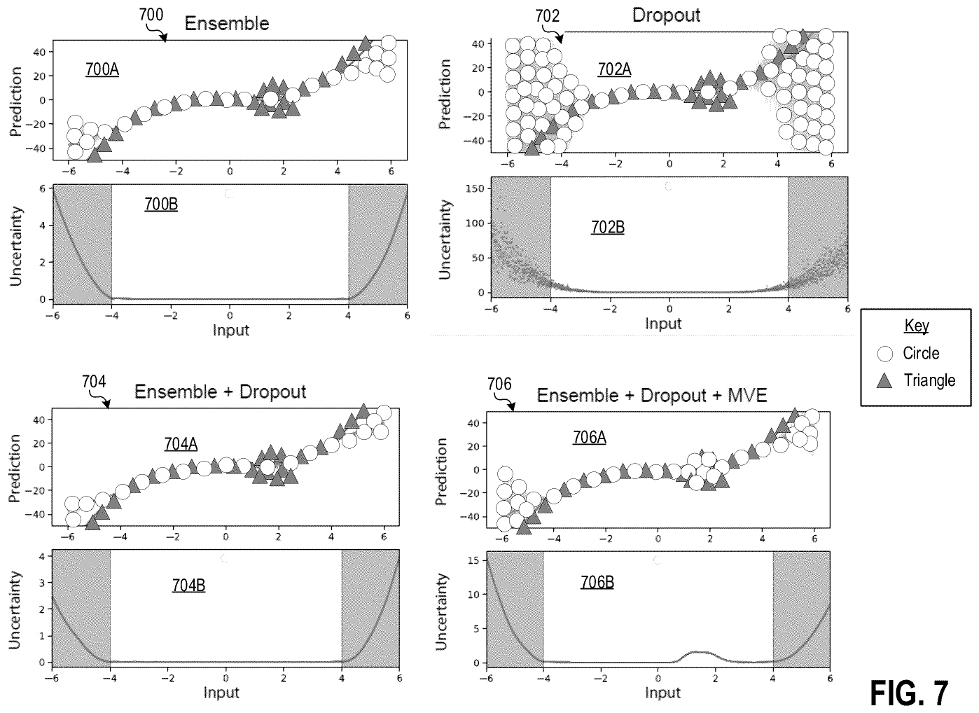

FIG. 7 illustrates example risk metrics on cubic regression using the disclosed technology. The disclosed epistemic methods can be benchmarked on toy datasets, in some implementations. The disclosed technology can be used to compose multiple methods (e.g., dropout and VAEs) and achieve more robust, efficient performance. Aleatoric methods can be combined with epistemic methods (e.g., ensembling a MVE metric) to strengthen aleatoric methods, at least because they can be averaged across multiple runs. The ensemble of MVEs can also be treated as a mixture of normals. Similarly, to combine VAE and dropout, a weighted sum of their variances can be used and/or the VAE can be run n times with dropout layers. The multiple runs can also be treated as N normal.

FIG. 7 shows example ensemble results 700, dropout results 702, ensemble and dropout results 704, and ensemble, dropout, and MVE results 706. In each of the results 700A, 702A, 704A, and 706A, triangles represent ground truth data (input x and label y) and circles represent the model's predictions (input x and predicted label y). Both triangles and circles are coarsely sampled for visualization, as the actual data is more fine grained. Given a pair of coordinates x and y, a point can be visualized in two-dimensional space (2D). In these examples, the training data is in the range [−4, 4] (on the X axis). During training, the model is fed X coordinates of the points and is trained to predict a Y coordinate for each corresponding data point. Test data can be in the range [−6, 6] (on the X axis). The model may not see these points during training. After training, X coordinates of points along the line in the plots 700A, 702A, 704A, and 706A can be fed to the model so that the model predicts Y coordinates of those points. As a result, both X and predicted Y coordinates for those points may be known and thus plotted.

At least because the model is not exposed to X points smaller than −4 or larger than 4 (on the X axis), these data points are out of distribution data for the model. In other words, it can be expected that the model may perform poorly on these data points. In fact, the predicted Y coordinates of the model diverge from the ground truth Y coordinates beyond the [−4, 4] range (on the X axis). This can indicate that the predictions of the model may be wrong on those data points beyond the [−4, 4] range. However, at least because the disclosed technology can automatically make models risk aware, in addition to the predictions, risk estimate for each predicted label, such as Y, can be computed. In plots 700B, 702B, 704B, and 706B, risk value (in this case, the risk value is epistemic uncertainty for the plots 700B, 702B, 704B; and a combination of epistemic and aleatoric uncertainty for the plot 706B) for each predicted label is plotted. The plots indicate that the model has highest risk estimates on inputs on which the model was never trained. Thus, simply by looking at the risk estimate of the model, out of distribution data points can be identified. The disclosed technology can be advantageous for understanding and improving deep learning models, which are trained on high dimensional datasets (e.g., images). At least because out of distribution data points may not be determined by simply looking at the high-dimensional data points alone, a risk value may be computed, as described herein, to accurately identify the out of distribution data points.

The results are provided for a regression dataset y=x+ϵ, where ϵ can be drawn from a Normal centered at x=1.5. Models can be trained on xϵ[−4, 4] and tested on xϵ[−6, 6], in an illustrative example. Composing using MVE can result in a single metric that can seamlessly detect epistemic and aleatoric uncertainty without any modifications to a model construction or training procedure.

One or more epistemic and/or aleatoric methods can be performed on a cubic dataset with injected aleatoric noise and a lack of data in some parts of the test set, as shown by the results 700, 702, 704, and 706 in FIG. 7. One or more models can be trained on y=x+ϵ, where ϵ˜(1.5, 0.9). Training data can be within [−4, 4] and test data can be within [−6, 6]. FIG. 7 demonstrates that composed metrics can successfully detect regions with high epistemic uncertainty (out of distribution data), as well as high aleatoric uncertainty (label noise) in the center.

Raw epistemic uncertainty methods can also be benchmarked on real-world regression datasets. VAEs, ensembles, and/or dropout uncertainty on these datasets can also be evaluated based on Root Mean Squared Error (RMSE) and/or negative log-likelihood (NLL), as shown in Table 1. In the Table 1, the leftmost column lists names of datasets and benchmarks used with the described techniques.

TABLE 1
Regression benchmarking on the UCI datasets

| | RMSE | | | NLL | | |
|---|---|---|---|---|---|---|
| | Dropout | VAE | Ensemble | Dropout | VAE | Ensemble |
| Boston | 2.449 +/− 0.134 | 2.323 +/− 0.117 | 2.589 +/− 0.113 | 2.282 +/− 0.03 | 2.497 +/− 0.047 | 2.253 +/− 0.056 |
| Power-Plant | 4.327 +/− 0.030 | 4.286 +/− 0.0120 | 4.221 +/− 0.028 | 2.892 +/− 0.00 | 2.964 +/− 0.00 | 2.841 +/− 0.005 |
| Yacht | 1.540 +/− 0.133 | 1.418 +/− 0.222 | 1.393 +/− 0.0965 | 2.399 +/− 0.03 | 2.637 +/− 0.131 | 1.035 +/− 0.116 |
| Concrete | 6.628 +/− 0.286 | 6.382 +/− 0.101 | 6.456 +/− 0.846 | 3.427 +/− 0.042 | 3.361 +/− 0.016 | 3.139 +/− 0.115 |
| Naval | 0.00 +/− 0.000 | 0.00 +/− 0.000 | 0.00 +/− 0.00 | 1.453 +/− 0.667 | −2.482 +/− 0.229 | −3.542 +/− 0.015 |
| Energy | 1.661 +/− 0.090 | 1.377 +/− 0.091 | 1.349 +/− 0.175 | 2.120 +/− 0.022 | 1.999 +/− 0.113 | 1.395 +/− 0.066 |
| Kin8nm | 0.088 +/− 0.001 | 0.0826 +/− 0.001 | 0.072 +/− 0.000 | −0.972 +/− 0.01 | −0.913 +/− 0.00 | −1.26 +/− 0.008 |
| Protein | 4.559 +/− 0.031 | 4.361 +/− 0.0156 | 4.295 +/− 0.029 | 4.452 +/− 0.012 | 3.345 +/− 0.011 | 2.723 +/− 0.023 |

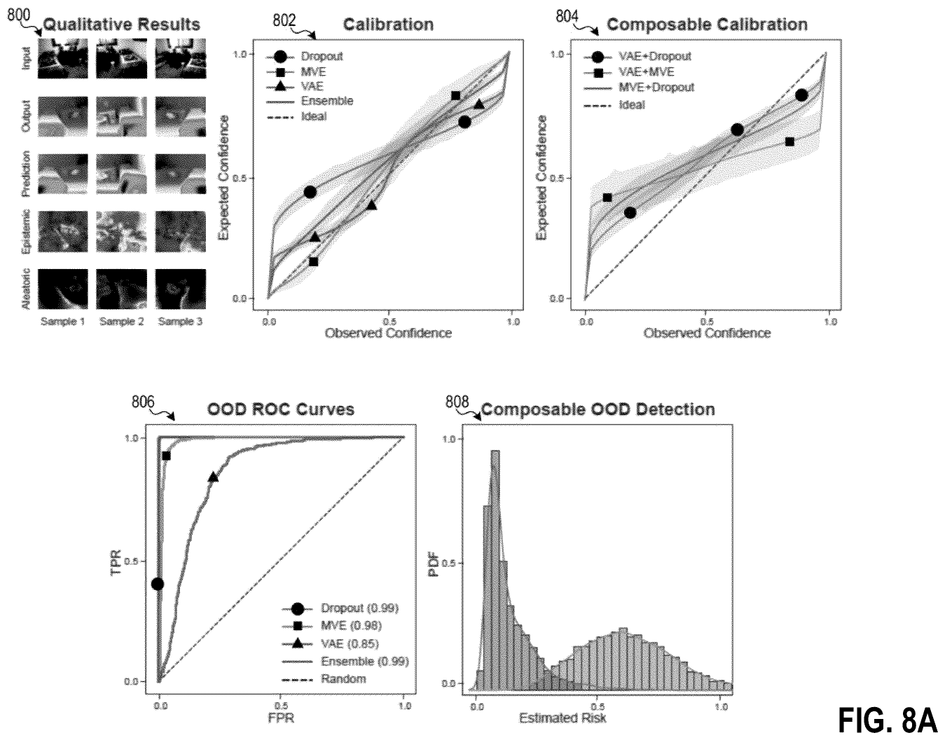

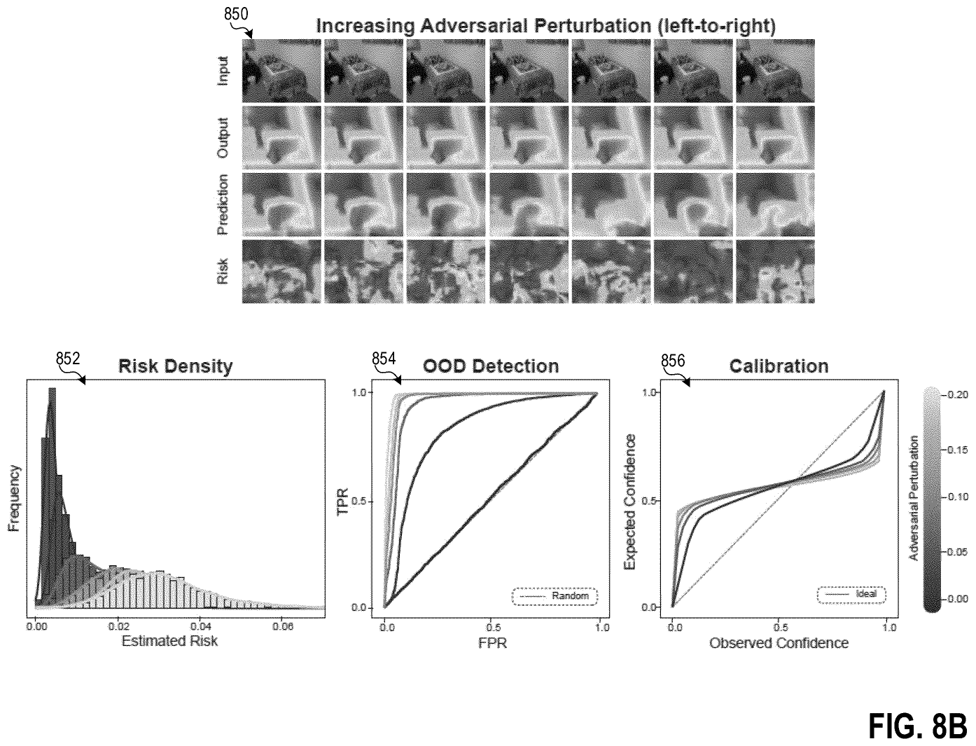

FIG. 8A illustrates example risk estimation on monocular depth prediction using the disclosed technology. The disclosed technology may also be used for anomaly detection. A model's epistemic uncertainty on out-of-distribution (OOD) data may be naturally higher than the epistemic uncertainty on in-distribution (ID) data of the same model. Given a risk aware model, density histograms of per image uncertainty estimates can be visualized and provided by a model on both ID (e.g., unseen test-set for a first dataset) and OOD data (e.g., a second dataset), as shown by a graph 808. At this point, OOD detection can be possible by simple thresholding techniques. Area Under the Curve-Receiver Operating Characteristics (AUC-ROC) may be used in some implementations to quantitatively assess separation of the two density histograms, where a higher AUC indicates a better quality of the separation, as shown by graph 806.

Qualitative results 800 can indicate example pixel-wise depth predictions and uncertainty. A calibration graph 802 depicts model uncertainty calibration for individual metrics, illustrating expected confidence versus observed confidence for various employed methods—as shown Dropout, MVE, VAE, and Ensemble—and comparing each against a determined ideal. A composable calibration graph 804 indicates model uncertainty calibration for composed metrics, illustrating expected confidence versus observed confidence for various combinations of employed methods—as shown VAE+Dropout, VAE+MVE, MVE+Dropout—and comparing each against a determined ideal.

More specifically, when a model is wrapped with an aleatoric method in the results 800, label noise and/or mislabeled data can be detected. The model can exhibit increased aleatoric uncertainty on object boundaries. The ground truth can have noisy labels, particularly along edges of objects, which can be due, at least in part, to sensor noise and/or motion noise. With an epistemic wrapper, uncertainty in the prediction of the model may be captured. Increased epistemic uncertainty may correspond to semantically and visually challenging pixels where the model returns erroneous output.

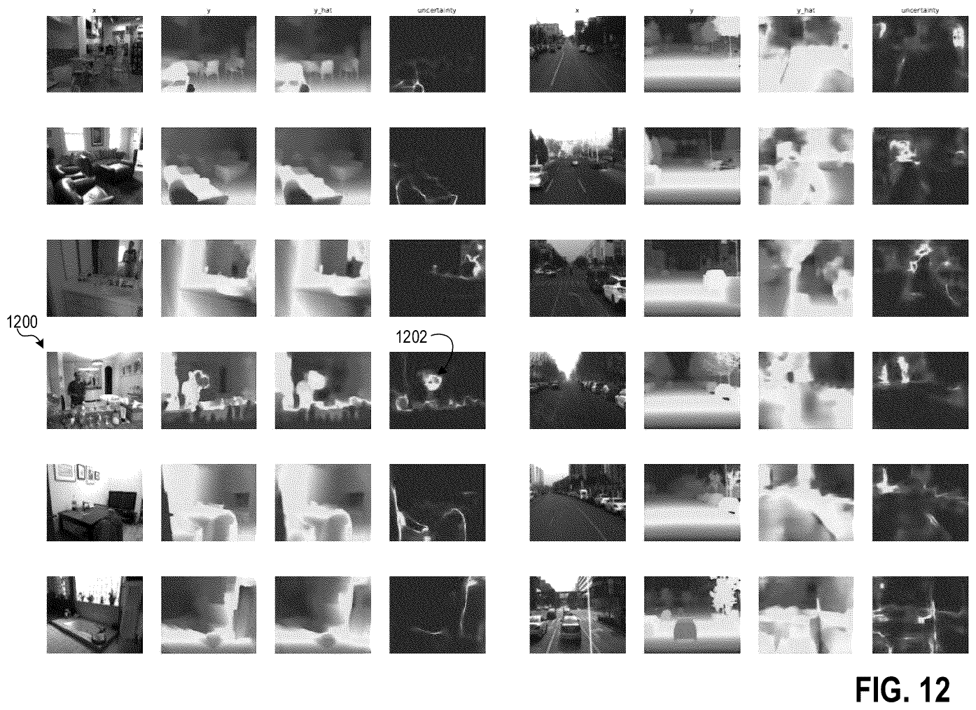

OOD ROC curves graph 806 depicts OOD detection assessed via AUC-ROC, the assessment being of a true positive rate (TPR) versus a false positive rate (FPR) for various employed methods—as shown again Dropout, MVE, VAE, and Ensemble—and comparing each against the diagonal line representing a random classifier. The OOD data points and detection are further described at least with respect to FIG. 12 below.

Composable OOD detection graph 808 illustrates a full probability density function (PDF) histogram. To achieve the results shown in the graph 808, a risk aware model can be run on two different datasets: (i) an ID dataset; and (ii) an OOD dataset. For each of the data points (e.g., images) in each of the datasets, the model can output a risk estimate, such as where a higher value indicates higher predicted risk. These risk estimates can be plotted in the graph 808, also referred to herein as histogram 808. Results plotted in the left half of the histogram 808 represent risk values on the ID dataset, while results plotted in the right half of the histogram 808 represent risk values on the OOD dataset. The model predicts higher risk values for the OOD dataset at least because the histogram 808 bins that the risk values, produced by running model on the OOD dataset, fall into bins further to the right, which indicates higher risk on the X axis. In real world scenarios, where nothing or little is known about what dataset a risk value is coming from, the disclosed technology can be useful to separate back the two datasets (identify out-of-distribution data points, and in-distribution data points), for example by assessing the risk values. For instance, in the histogram 808, two peaks formed. If a line is drawn (in between the peaks) perpendicular to an X axis, the result would be that to the right of the line are the OOD data points and to the left of that line are the ID data points. Accordingly, the disclosed technology may be used to separate out the two datasets by assessment of the risk values, which allows a risk aware model produced using the disclosed technology to perform OOD detection.

FIG. 8B illustrates example robustness under adversarial noise. Example dataset 850 shows pixel-wise depth predictions and uncertainty visualizations. Graph 852 shows risk density histograms of per image uncertainty from images in the dataset 850, comparing estimated risk to frequency. Graph 854 shows OOD detection assessed via AUC-ROC, plotting FPR versus TPR, as compared to the diagonal line representing a random classifier. Graph 856 that shows calibration curves, plotting observed confidence versus expected confidence, as compared to the diagonal line representing a perfectly calibrated model. Adversarial perturbations are illustrated across the graphs 850, 852, 854, and 856 based on shading, as indicated by the key. Adversarial perturbations can be interpreted as a way of gradually turning ID data points into OOD (see the dataset 850). Such a granular control can allow for an improved model introspection. As shown by FIG. 8B, as epsilon of the perturbation increases, the density histograms of per image uncertainty estimates provided by a model on both the ID and perturbed images can become more disentangled (see, e.g., the graph 852) and the quality of separation may increase (see, e.g., the graph 854).

Similar to FIG. 8A, FIG. 8B shows an application of the uncertainty estimation functionality of the disclosed technology, to anomaly detection. It may be important for a model to recognize that it is presented with an unreasonable input (e.g., OOD). By way of non-limiting example, in real world implementation, this can be applied to autonomous vehicles yielding control to humans if a perception system detects that it is presented with such an input image as it is expected that performance of that model on this data point may be poor. As shown by example data set 1100, as the more the images become out of distribution (OOD), the more depth estimates degrade. However, at least because the disclosed technology provides for detecting such a distribution shift, the model can pass this information downstream, avoiding potentially inaccurate and/or disastrous predictions before it actually happens.

Moreover, the disclosed technology can be used to detect adversarial attacks (e.g., adversarial perturbations). As shown in FIG. 8B, even though a perturbed image from the dataset 850 may not be immediately distinguishable to a human eye, the disclosed technology can be used to successfully detect altered input images.

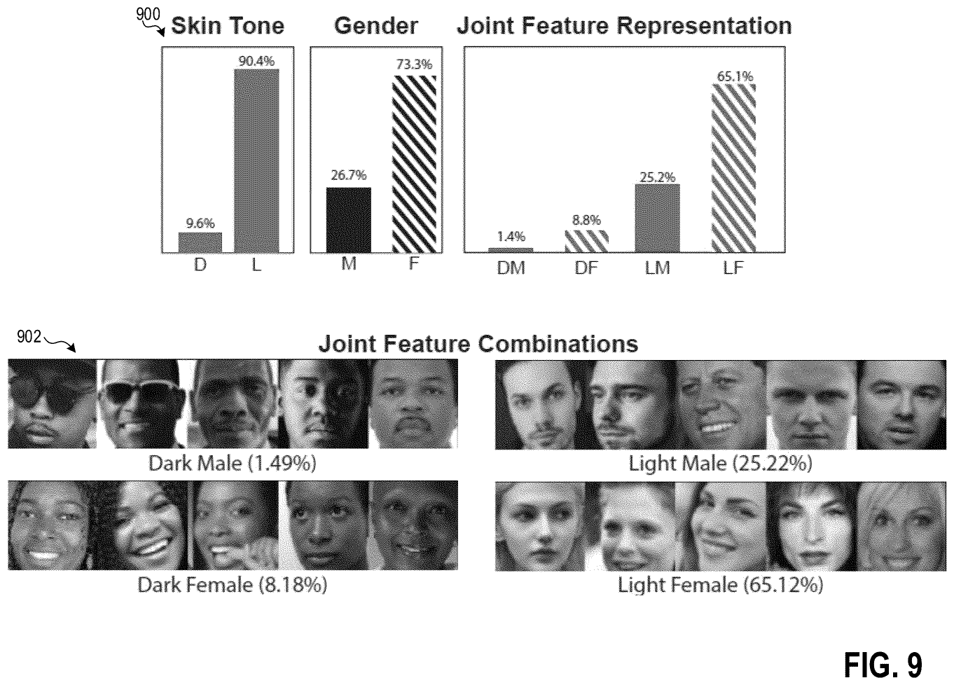

FIG. 9 illustrates de-biasing facial recognition systems using the disclosed technology. The benefits of seamlessly and efficiently integrating a variety of risk estimation methods into arbitrary neural network models can extend beyond benchmarking and unifying these algorithms. Using de-biasing tools provided by the disclosed technology, one application is to not only estimate and identify imbalance in a dataset, but to also actively reduce bias, for example by adaptively re-sampling data points depending on their estimated representation bias during model training.

As shown in FIG. 9, using the disclosed technology, exact samples can be identified as needing under and/or over-sampling. More particularly, FIG. 9 illustrates determinations made about dark (D) versus light (L) skin tone, male (M) versus female (F) gender, and then combinations of the same, i.e., males having dark skin tone (DM), females having dark skin tone (DF), males having light skin tone (LM), and female having light skin tone (LF). These findings can be used to intelligently resample from the dataset during training, instead of sampling uniformly. The benefits of this are twofold—sample efficiency can be improved by training on less data if some data is redundant and oversampling can be performed from areas of the dataset where latent representation may be more sparse.

By composing multiple risk metrics together (in this case, VAEs and histogram bias), greater robustness during training can be achieved, including more sample efficiency, and a combination of epistemic uncertainty and bias to reduce risk while model training.

Graphs 900 indicate that facial datasets can be biased towards light-skinned females. Data 902 indicates that feature combinations present in dark-skinned males can make up only 1.49% of the facial dataset, and those present in dark-skinned female faces may only take up approximately 8.18% of the dataset. Since the disclosed technology can provide information indicating which exact data points are underrepresented, an improved sampling scheme can be implemented to increase representation of these feature combinations in the dataset.

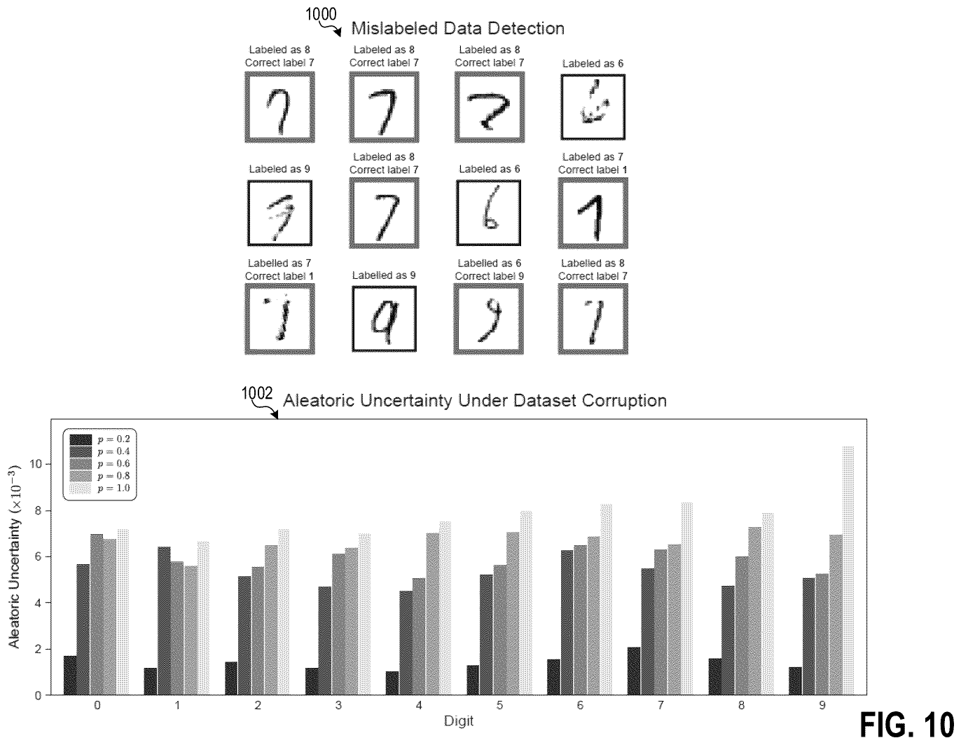

FIG. 10 illustrates examples of mislabeled data 1000 in a dataset, which can be assessed using the disclosed technology. Histogram 1002 illustrates aleatoric uncertainty under dataset corruption using the dataset shown by the data 1000. The disclosed technology can be used for cleaning mislabeled and/or noisy datasets, at least because the disclosed technology may identify noisy labels with high accuracy. In the example of FIG. 10, a random collection of 7s can be replaced in a dataset with 8s (e.g., 20%). As shown by the mislabeled data 1000, samples with high aleatoric uncertainty may be dominated by the mislabeled data and also may include a naturally mislabeled sample.

The sensitivity to mislabeled datasets of the disclosed technology may also be tested by artificially corrupting the labels with varying levels of probability p. As shown by the histogram 1002, as p increases, the average aleatoric uncertainty per class may also increase. These illustrative examples in FIG. 10 highlight the capability of the disclosed technology to serve as a backbone of a dataset quality controller and cleaner, which can be due, at least in part, to the high-fidelity aleatoric noise detection of the disclosed technology.

FIG. 11A is a flowchart of a process 1100 for applying an alternative implementation of a wrapper (at initialization stage) to a machine learning model, using the disclosed technology. FIG. 11B is a flowchart of a process 1120 for applying an alternative implementation of wrapper composability (at initialization stage) to a machine learning model, using the disclosed technology. FIG. 11C is a conceptual diagram of a process 1140 for applying an alternative implementation of wrapper composability (at initialization stage), using the disclosed technology, but visualized differently than FIG. 11B. FIG. 11D is a flowchart 1150 of an alternative implementation of wrapper composability (during training stage), using the disclosed technology. The processes of FIGS. 11A, 11B, 11C, and 11D may be performed by any of the computer systems described herein. For illustrative purposes, the processes are described from the perspective of a computer system.

Inline with the definition of a wrapper above, multiple concrete implementations of a wrapper are possible within the framework of the disclosed technology. The techniques illustrated in FIGS. 2A, 2B, 2C, and 4, combined, describe one such possible concrete implementation of a wrapper within the disclosed technology. The techniques illustrated in FIGS. 11A, 11B, 11C, and 11D, combined, describe an alternative possible implementation of a wrapper within the disclosed technology. These two implementations are separate and independent from each other and are meant to serve as illustrative examples. The disclosed technology is not limited to these two specific implementations. A person skilled in the art, in view of the present disclosures, will appreciate other implementations are possible, in line with the definition of a wrapper above. In comparison to the techniques described in FIGS. 2A, 2B, 2C, and 4, the techniques shown and described in FIGS. 11A, 11B, 11C, and 11D frame a problem of transforming a model into its risk-aware variant as modifications of the computational graph of the model and apply wrappers to the entire model. The techniques described in FIGS. 2A, 2B, 2C, and 4 express modifications to a backbone of a model as changes to a Layer class abstraction (e.g., torch.nn.*, tf.keras.layers.*, and alike) inside a deep learning framework, isolating a shared feature extractor, and applying wrappers to that specific part of the model.

More generally, the techniques described in reference to FIGS. 11A, 11B, 11C, and 11D include representing a user model as a graph of mathematical operations (e.g., computational operations) and modifying the graph of operations of this model to make the user model risk-aware (see, e.g., FIG. 11C). Wrappers are abstractions containing logic for turning a model (represented as a graph of mathematical operations) into its risk-aware variant, by modifying (e.g., adding, deleting, replacing) mathematical operations performed by that model. Advantageously, such techniques can be generally applicable to complex real world models. Further, making the wrappers operate on a level of individual mathematical operations can allow the performance of more granular and less constrained modifications of a user model. A wrapper, by way of a non-limiting example, can add subgraphs of mathematical operations to the computational graph representing the user model. These operations (e.g., their type and how they are connected), among others, may contain wrapper-specific logic for computing a risk estimate (e.g., a wrapper that computes the epistemic risk may add a group of operations that introduce stochasticity into the model and some way to sample from that added stochasticity, thus allowing to estimate the risk).

Referring to the process 1100 in FIG. 11A, which provides an example implementation of an individual wrapper, the computer system receives a user model in block 1102. In block 1104, the computer system may apply a wrapper-specific algorithm to generate a risk-aware variant of the user model. Each wrapper (e.g., a batch ensemble wrapper, a dropout wrapper, an ensemble wrapper, a LoRA wrapper) can contain logic (e.g., written in code) for specific modifications that may be performed on the user model. The exact modifications may not be shared between the wrappers.

For example, the computer system may apply one or more other search, node/subgraph (e.g., addition, deletion, replacement) transformations to the model (block 1106). Each wrapper can modify a computational graph of the user model, with the computational graph containing, for example, mathematical operations performed by the model. Each wrapper can add, delete, and/or replace individual mathematical operations and/or subgraphs of these operations or group/groups of these subgraphs, as illustrative examples. Accordingly, the logic of what model transformations need to be applied can be contained inside each wrapper so that a wrapper can take in the user model and automatically transform it. In the example of an epistemic wrapper, the epistemic wrapper may add probabilistic layers (e.g., a group of mathematical operations that represent a probabilistic layer) to the user model. This wrapper may also execute logic that can cause the wrapper to calculate the uncertainty it needs to run the user model T times. Each wrapper may contain logic indicating what operations the wrapper needs to add, delete, and/or replace. Similar logic described herein for inserting operations may be used for replacement or deletion of operations in the user model.

Optionally, the computer system may apply a loss function module to the user model in block 1108. Each wrapper may contain logic that specifies a particular loss function to be applied. The computer system returns the risk-aware variant of the user model in block 1110, as described herein.

Referring to the process 1120 in FIG. 11B, the computer system can receive user input associated with a user model (block 1122), as described herein. For example, the computer system may receive an original user model in block 1124. The computer system may receive a list of metrics to be used in block 1126.

The computer system can select a composable wrapper amongst a plurality of composable wrappers, based, for example, on the user-specified metrics in block 1128. In block 1130, the computer system can provide the entire user model to the selected composable wrapper. The computer system may then proceed to perform blocks 1102-1108 in the process 1100 of FIG. 11A. Advantageously, the disclosed process 1120 is more generalized and allows for application to complex real-world models.

Once the blocks 1102-1108 are performed, the computer system may determine whether there are more user-specified metrics in the list in block 1132. If inside a single wrapper the model has been transformed but the list of metrics provided by a user specifies additional risk factors to be estimated, this can trigger additional model modifications (e.g., sequential composability of wrappers, which can be the result of one wrapper being fed to another wrapper). What specific transformations may need to be applied to the model in this case can be defined by, for example, the second wrapper. Composability may not be limited to only two wrappers; any number of wrappers can be applied.

If there are more metrics in the list, the computer system can return to block 1128 and proceed through the process 1120 described above. If there are no more metrics in the list, the computer system can return the risk-aware variant of the user model in block 1134.

The process 1140 in FIG. 11C represents a conceptual diagram of applying an alternative implementation of wrapper composability (at initialization stage), but visualized differently than FIG. 11B. In the process 1140, a wrapper inputs a user model 1170, defined in a particular deep learning framework (e.g., PyTorch, Tensorflow, JAX, or others). This can make the model “framework-specific,” meaning code that a user used to define the user model 1170 is specific to a particular framework and natively that model may not be executed in another framework.

The user model 1170 can be traced 1172 to extract a graph of mathematical operations that represents the user model 1170. Native components of the underlying framework in which the user defined the model 1170 may be used to perform the tracing 1172 (e.g., rely on torch.compile to extract the graph if the user defined the model in PYTORCH, rely on TENSORFLOW's FUNCGRAPH object to extract the graph if the user defined their model in TENSORFLOW, etc.). Tracing 1172 can result in returning a graph representing the user model, which can be framework-specific. An optional extension to this component is: to natively integrate wrapping with a tracing mechanism of each deep learning framework, the computer system can “hook into” the tracing mechanism of each framework to gain convenient access to the graph representing the user model 1170, making the integration of wrapping with each particular framework both native and robust.

The computer system may then implement a translation module 1174 that can translate the framework-specific graphs of mathematical operations (e.g., tensorflow. FuncGraph, torch.fx.Graph, etc.) to a framework-agnostic (meaning the same for all frameworks) representation. This allows the downstream components of the computer system, e.g., wrappers, to be implemented in a way to support transforming this framework-agnostic representation while automatically working for all the user frameworks. As a result, a single framework-agnostic implementation of the wrappers can be provided by the computer system, thereby reducing code duplication (at least because the alternative is to implement framework-specific wrappers, which would require substantially more code to maintain).

Block 1176 in the process 1140 provides a schematic of sequential composability of wrappers, which can be the result of one wrapper being fed to another wrapper. The block 1176 also illustrates changes to the graph, representing the user model with dotted circles. As described in reference to the process 1120 in FIG. 11B, application of a wrapper to the graph representing the user model can make that graph (and by extension the model) risk-aware.

Output from the block 1176 can be fed to a translation module 1178. The module 1178 may translate the modified framework-agnostic graph back to the original user framework (e.g., if the user provided a model in pytorch, then translate back to pytorch; the same logic can apply for other frameworks). The modified model may then be returned in block 1180 (e.g., to the user and/or to a data store or another computing system described herein).

The process 1150 in FIG. 11D shows a training process of a risk aware model (i.e., of a user model that has already been wrapped with the processes described above in FIGS. 11A, 11B, and/or 11C).

In the process 1150, the computer system can receive user input associated with a user model (block 1152). The input may include training data, containing inputs and/or ground truth labels (block 1154). Sometimes, the inputs during training may be the same as inputs before wrapping the model. Therefore, training a wrapped model may not always require making additional modifications to the training process on the part of a user.

The computer system may execute the entire model on the inputs in block 1156. For example, the computer system may run a forward pass of the risk aware model on the provided inputs, thereby producing output. This operation may execute computational operations contained inside the risk aware model.

In block 1158, the computer system can jointly optimize the model on all associated losses (or a subset or portion thereof). In other words, the computer system may update/train learnable parameters of the risk aware model. For example, the computer system may compute a combined loss as an average of user-specified loss(es) and wrapper loss(es) (block 1160). During training, the risk aware model may have multiple objectives (losses) to minimize. This may be due, at least in part, to the fact that each wrapper may specify its own loss function (see, e.g., the process 1100 in FIG. 11A), and because the process 1150 provides training for composability setting (e.g., result of one wrapper being fed to another wrapper, as described in reference to block 1132 in the process 1120 of FIG. 11B). Therefore, the model, which can be optimized using the process 1150, may have multiple additional loss functions added to it, for instance by each respective wrapper that it was wrapped with (e.g., as described in FIG. 11B regarding composability during an initialization stage). In addition to the losses that were added during wrapping, the original model may contain one or more user specified losses. To combine all of these losses into a single value, the computer system can average them out, although the implementation is not limited only to averaging, as other ways of combining the losses, such as weighted average, and others, are also possible.

As another example, the computer system may compute gradient of the combined loss with respect to risk-aware model parameters (block 1162). As yet another example, the computer system may update one or more trainable parameters or the risk-aware model based on the computed gradient (block 1164).The computer system may then return the optimized model for runtime use in block 1166.

FIG. 12 illustrates example noise and mislabeled data, which can be identified using the aleatoric method techniques described herein. When a model is wrapped with the aleatoric method, label noise and mislabeled data can be detected. For example, as shown in images 1200 and 1202, a ground truth label has a mislabeled blob of pixels near the right shoulder of a person. The wrapped model can detect this and selectively assign high aleatoric uncertainty to this region while leaving the correctly labeled parts of the image untouched.

The disclosed technology can be used as a large-scale risk and uncertainty benchmarking framework. For example, a U-Net style model can be trained on a task of monocular end-to-end depth estimation, as shown by Table 2. Importantly, the disclosed technology can work “out of the box” without requiring modifications at least because the technology is a highly configurable, model-agnostic framework with modularity as a core of its design principles.

TABLE 2
Depth regression results. VAE + dropout outperforms
all other epistemic methods and is more efficient.

| | Test Loss | NLL | OOD AUC |
|---|---|---|---|
| Base | 0.0027 ± 0.0002 | — | — |
| VAE | 0.0027 ± 0.0001 | — | 0.8855 ± 0.0361 |
| Dropout | 0.0027 ± 0.0001 | 0.1397 ± 0.0123 | 0.9986 ± 0.0026 |
| Ensembles | 0.0023 ± 7e−05 | 0.0613 ± 0.0217 | 0.9989 ± 0.0018 |
| MVE | 0.0036 ± 0.0010 | 0.0532 ± 0.0224 | 0.9798 ± 0.0118 |
| Dropout + | 0.0027 ± 0.0001 | 0.1291 ± 0.0146 | 0.9986 ± 0.0026 |
| MVE | | | |
| VAE + | 0.0027 ± 0.0001 | 0.0932 ± 0.0201 | 0.9988 ± 0.0024 |
| Dropout | | | |
| VAE + MVE | 0.0034 ± 0.0012 | 0.1744 ± 0.0156 | 0.9823 ± 0.0102 |

More specifically, a U-Net style model whose final layer outputs a single H×W activation map can be wrapped with the disclosed technology. The wrapped model can then be trained on a dataset, like the dataset shown in FIG. 12, which can include 27k RGB-to-depth image pairs of indoor scenes. The trained model can be evaluated on a disjoint test-set of scenes. Additionally, outdoor driving images can also be used as OOD data points in this illustrative example.

When the model is wrapped with an aleatoric method, label noise or mislabeled data can be successfully detected (refer to images 1200 and 1202). The model can exhibit increased aleatoric uncertainty on object boundaries. The ground truth may have noisy labels, particularly on edges of the objects in the images. Such noisy labels can be due, at least in part, to sensor noise and/or motion noise, in at least some implementations.

With dropout and/or ensemble wrappers, uncertainty can be captured in the prediction of the model itself. Accordingly, increased epistemic uncertainty may correspond to semantically and visually challenging pixels where the model may be making errors.

FIG. 13 is a system diagram of components that can be used to perform the disclosed technology. The risk analysis computer system 102, the user device(s) 104, and the data store 106 can communicate via the network(s) 108, all of which are described in greater detail above and/or understood by a person skilled in the art in view of the present disclosures, in addition to what is described below.

The computer system 102 can include one or more composable wrappers 1326A-N (e.g., implementation-specific), each wrapper having a wrapper-specific algorithm 1325 and an optional loss function module 1310, a risk factor output generator 1312, an optional model adjustment recommendation engine 1314, a risk awareness improvement engine 1316, processor(s) 1318, and a communication interface 1320. The processor(s) 1318 can be configured to execute instructions that cause the computer system 102 to perform one or more operations. The one or more operations can include any of the operations and/or processes described herein and/or in reference to the components of the computer system 102. The communication interface 1320 can be configured to provide communication between the system components described in FIG. 13.

In some implementations, one or more of the components of the computer system 102 can be software modules that are executed in code at the computer system 102. Sometimes, the components can be hardware-based components of the computer system 102 that are configured to execute the operations described herein.

Still referring to the computer system 102, each of the composable wrappers 1326A-N may be configured to execute or otherwise wrap the original user model(s) 1322 using the wrapper-specific algorithm 1325. The composable wrappers 1326A-N can be abstractions containing logic for turning a model, represented, for example, as a graph of mathematical operations, into its risk-aware variant by modifying (e.g., adding, deleting, replacing) one or more of the mathematical operations performed by the model. The composable wrappers 1326A-N, therefore, can be configured to automatically transform the graph representing the user model, instead of requiring users to manually rewrite their code for the model. The composable wrappers 1326A-N can be selected from the data store 106 using a list of metrics 1324 that correspond to the respective original user model(s) 1322. Sometimes, each of the risk metrics in the list 1324 may correspond to one or more wrappers amongst the plurality of wrappers 1326A-N. As an illustrative example, an “epistemic” risk metric may correspond to multiple wrappers including, but not limited to, a batch ensemble wrapper, a random networks wrapper, a dropout wrapper, and/or an ensemble wrapper.

The list of metrics 1324 can be defined by a user at the user device 104 and provided to the computer system 102 to identify one or more types or categories of risk to assess in the respective original user model(s) 1322. Sometimes, the list of metrics 1324 can be predefined. The list of metrics 1324 can, for example, be provided as a list of strings (e.g., “epistemic,” “aleatoric,” etc.) by the user at their user device 104. The computer system 102 can then select one or more of the wrappers 1326A-N for each of the specific strings in the list. As an illustrative example, a Dropout wrapper can be applied and configured to compute epistemic risk and/or a MVE wrapper can be configured to compute aleatoric risk. The list of metrics 1324 can therefore include types of risk that the relevant user may desire to be assessed.

In some implementations, the wrappers 1326A-N can also generate output indicating one or more model risk factors 1332A-N described herein. Modifications may also be made to parts of the model(s) 1322 by each of the composable wrappers 1326A-N and based on wrapper-specific modifications. The wrappers 1326A-N may each augment one or more computational operations and/or model components of the model(s) 1322. The wrappers 1326A-N may additionally or alternatively transform the model(s) 1322. Further details about augmentation techniques is provided herein at least with respect to descriptions associated with FIG. 4.

The optional loss function module 1310 can be configured to perform a loss function on the model(s) 1322. The risk factor output generator 1312 can be configured to generate information about risks in the original user model(s) 1322 using the risk-aware model 1340, which may be generated by the wrappers 1326A-N using the wrapper-specific algorithm 1325 (e.g., logic). The generator 1312 may generate representation bias output 1334, epistemic uncertainty output 1336, and/or aleatoric uncertainty output 1338. The generator 1312 can create any combination of such outputs 1334, 1336, and/or 1338 using the disclosed techniques. The generator 1312 can also generate any other output and/or information about other risk factors that are assessed using the disclosed techniques.

The optional model adjustment recommendation engine 1314 can be configured to generate one or more recommendations about how to improve the original user model(s) 1322 based on the model risk factors 1332A-N and/or the outputs 1334, 1336, and/or 1338. The engine 1314 can provide such recommendations to the user device(s) 104 for selection and/or implementation. Sometimes, the engine 1314 can provide such recommendations to the risk factor output generator 1312 to generate a notification, instructions, alert, message, and/or other output regarding the recommendations to the user device(s) 104. In some implementations, the engine 1314 can implement one or more of the recommendations and therefore automatically adjust the original user model(s) 1322 based on the one or more risk factors 1332A-N.

The risk awareness improvement engine 1316 can be configured to iteratively improve one or more of the operations performed by the modules described herein. The iterative improvements can be made over time, at predetermined time intervals, whenever user input is received, and/or whenever the original user model(s) 1322 undergoes risk assessments using the disclosed techniques. As a result, the disclosed techniques can be applied to the different model(s) 1322 that may be generated and assessed based on different types and/or categories of risk.

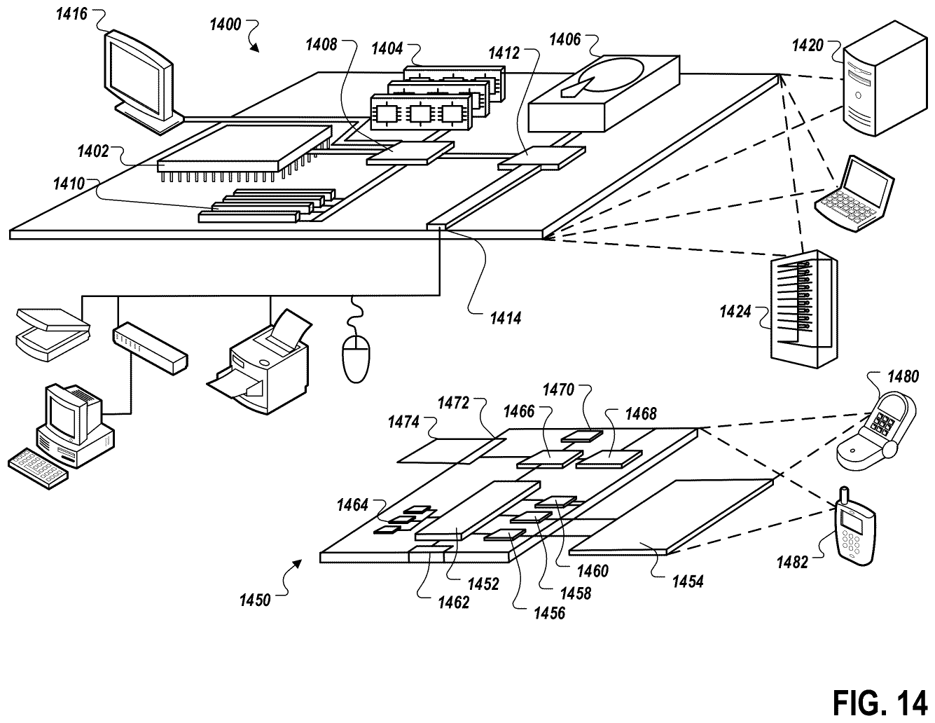

FIG. 14 shows an example of a computing device 1400 and an example of a mobile computing device 1450 that can be used to implement the techniques described here. The computing device 1400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this disclosure.

The computing device 1400 includes a processor 1402, a memory 1404, a storage device 1406, a high-speed interface 1408 connecting to the memory 1404 and multiple high-speed expansion ports 1410, and/or a low-speed interface 1412 connecting to a low-speed expansion port 1414 and the storage device 1406. Each of the processor 1402, the memory 1404, the storage device 1406, the high-speed interface 1408, the high-speed expansion ports 1410, and the low-speed interface 1412, can be interconnected using various busses, and can be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as a display 1416 coupled to the high-speed interface 1408. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. Additionally, or alternatively, in some implementations, the memory 1404 is a non-volatile memory unit or units. Further additionally, or alternatively, the memory 1404 can be another form of computer-readable medium, such as a magnetic or optical disk.

The storage device 1406 is capable of providing mass storage for the computing device 1400. In some implementations, the storage device 1406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1404, the storage device 1406, and/or memory on the processor 1402.

The high-speed interface 1408 manages bandwidth-intensive operations for the computing device 1400, while the low-speed interface 1412 manages lower bandwidth-intensive operations. Such allocation of functions is exemplary only. In some implementations, the high-speed interface 1408 is coupled to the memory 1404, the display 1416 (e.g., through a graphics processor or accelerator), and to the high-speed expansion ports 1410, which can accept various expansion cards (not shown). In the implementation, the low-speed interface 1412 can be coupled to the storage device 1406 and the low-speed expansion port 1414. The low-speed expansion port 1414, which can include various communication ports (e.g., USB, Bluetooth, Ethernet, wireless Ethernet) can be coupled to one or more input/output devices, such as a keyboard, a pointing device, a scanner, and/or a networking device such as a switch and/or router, e.g., through a network adapter.

The computing device 1400 can be implemented in a number of different forms, as shown in the figure. For example, it can be implemented as a standard server 1420, or multiple times in a group of such servers. Additionally, it can be implemented in a personal computer such as a laptop computer 1422. It can also be implemented as part of a rack server system 1424. Alternatively, components from the computing device 1400 can be combined with other components in a mobile device (not shown), such as the mobile computing device 1450. Each of such devices can contain one or more of the computing device 1400 and the mobile computing device 1450, and an entire system can be made up of multiple computing devices communicating with each other.

The mobile computing device 1450 includes a processor 1452, a memory 1464, an input/output device such as a display 1454, a communication interface 1466, and/or a transceiver 1468, among other components. The mobile computing device 1450 can also be provided with a storage device, such as a micro-drive or other device, to provide additional storage. Each of the processor 1452, the memory 1464, the display 1454, the communication interface 1466, and/or the transceiver 1468, can be interconnected using various buses, and several of the components can be mounted on a common motherboard or in other manners as appropriate.

The processor 1452 can execute instructions within the mobile computing device 1450, including instructions stored in the memory 1464. The processor 1452 can be implemented as a chipset of chips that include separate and multiple analog and digital processors. The processor 1452 can provide, for example, for coordination of the other components of the mobile computing device 1450, such as control of user interfaces, applications run by the mobile computing device 1450, and wireless communication by the mobile computing device 1450.

The processor 1452 can communicate with a user through a control interface 1458 and a display interface 1456 coupled to the display 1454. The display 1454 can be, for example, a Thin-Film-Transistor Liquid Crystal Display (TFT) display or an Organic Light Emitting Diode (OLED) display, or other appropriate display technology. The display interface 1456 can comprise appropriate circuitry for driving the display 1454 to present graphical and other information to a user. The control interface 1458 can receive commands from a user and convert them for submission to the processor 1452. Additionally, an external interface 1462 can provide communication with the processor 1452, so as to enable near area communication of the mobile computing device 1450 with other devices. The external interface 1462 can provide, for example, for wired communication in some implementations, or for wireless communication in other implementations, and multiple interfaces can also be used.

The memory 1464 stores information within the mobile computing device 1450. The memory 1464 can be implemented as one or more of a computer-readable medium or media, a volatile memory unit or units, and/or a non-volatile memory unit or units. An expansion memory 1474 can also be provided and connected to the mobile computing device 1450, for example through an expansion interface 1472, which can include, for example, a SIMM (Single In Line Memory Module) card interface. The expansion memory 1474 can provide extra storage space for the mobile computing device 1450, or can also store applications or other information for the mobile computing device 1450. Specifically, the expansion memory 1474 can include instructions to carry out or supplement the processes described above, and can include secure information also. Thus, for example, the expansion memory 1474 can be provide as a security module for the mobile computing device 1450, and can be programmed with instructions that permit secure use of the mobile computing device 1450. Additionally, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1464, the expansion memory 1474, and/or memory on the processor 1452. In some implementations, the computer program product can be received in a propagated signal, for example, over the transceiver 1468 or the external interface 1462.

The mobile computing device 1450 can communicate wirelessly through the communication interface 1466, which can include digital signal processing circuitry where necessary and/or appropriate. The communication interface 1466 can provide for communications under various modes or protocols, such as Global System for Mobile communications (GSM) voice calls, Short Message Service (SMS), Enhanced Messaging Service (EMS), Multimedia Messaging Service messaging (MMS), code division multiple access (CDMA), time division multiple access (TDMA), Personal Digital Cellular (PDC), Wideband Code Division Multiple Access (WCDMA), CDMA2000, and/or General Packet Radio Service (GPRS), among others. Such communication can occur, for example, through the transceiver 1468 using a radio-frequency. Further, short-range communication can occur, such as using a Bluetooth, WiFi, and/or other such transceiver (not shown). Additionally, a Global Positioning System (GPS) receiver module 1470 can provide additional navigation- and location-related wireless data to the mobile computing device 1450, which can be used as appropriate by applications running on the mobile computing device 1450.

The mobile computing device 1450 can also communicate audibly using an audio codec 1460, which can receive spoken information from a user and convert it to usable digital information. The audio codec 1460 can likewise generate audible sound for a user, such as through a speaker, e.g., in a handset of the mobile computing device 1450. Such sound can include sound from voice telephone calls, can include recorded sound (e.g., voice messages, music files, etc.) and can also include sound generated by applications operating on the mobile computing device 1450.

The mobile computing device 1450 can be implemented in a number of different forms, as shown in the figure. For example, it can be implemented as a cellular telephone 1480. It can also be implemented as part of a smart-phone 1482, personal digital assistant, or other similar mobile device.

Various implementations of the systems and techniques described here can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and/or at least one output device.

These computer programs (also known as programs, software, software applications or code) can include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, and/or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims. Notably, unless otherwise stated herein as not being possible or understood by a person skilled in the art as not being possible, any recitation of one claim is typically combinable with any recitation of any other claim and/or within the skill of the art to determine how such an embodiment would be created by combining the recitations across multiple claims.

1. A method for performing a risk assessment on a machine learning model, the method comprising:
receiving, by a computer system from at least one of a user device or a data store, a user model and a list of one or more risk metrics, wherein the one or more risk metrics indicate types of risk factors to assess for the user model;
selecting, by the computer system, a composable wrapper from a plurality of composable wrappers for wrapping the user model based on a risk metric in the list of risk metrics, wherein each of the plurality of composable wrappers corresponds to a different type of risk factor, wherein each of the plurality of composable wrappers is configured to modify mathematical operations that the user model computes;
applying, by the computer system and for the selected composable wrapper, a wrapper-specific algorithm to the user model to generate a risk-aware variant of the user model, wherein applying the wrapper-specific algorithm to the user model comprises modifying the mathematical operations computed by the user model to produce a risk estimate for the user model and predictions of the user model; and
returning, by the computer system, the risk-aware variant of the user model.

2. The method of claim 1, wherein modifying the mathematical operations computed by the user model to produce a risk estimate for the user model and predictions of the user model comprises modifying a computational graph of the user model.

3. The method of claim 2, wherein modifying a computational graph of the user model comprises using a shared feature extractor to do at least a portion of the modifying a computational graph of the user model.

4. The method of claim 1, wherein modifying the mathematical operations computed by the user model to produce a risk estimate for the user model and predictions of the user model comprises using a shared feature extractor to do at least a portion of the modifying the mathematical operations.

5. The method of claim 1, wherein modifying the mathematical operations computed by the user model to produce a risk estimate for the user model and predictions of the user model comprises:
modifying higher-level abstractions of a deep learning library for the user model,
wherein the higher-level abstractions include at least one of:
(i) layers; or
(ii) modules,
wherein modifying the higher-level abstractions causes at least one of:
(i) modification of a computational graph of the user model; or
(ii) creation of additional computational graphs of the user model.

6. The method of claim 1, wherein modifying the mathematical operations computed by the user model to produce a risk estimate for the user model and predictions of the user model comprises:
modifying abstractions of a particular programming language of the user model,
wherein the abstractions of the particular programming language include at least one of PYTHON abstract syntax trees, PYTHON concrete syntax trees, PYTHON code, or C++ code.

7. The method of claim 1, further comprising:
extracting, by the computer system, a shared backbone model from the user model;
extracting, by the computer system, features from input with the shared backbone model; and
providing, by the computer system, the shared backbone model to one or more of the plurality of composable wrappers to generate the risk-aware variant of the user model.

8. The method of claim 1, wherein the plurality of composable wrappers comprises a wrapper configured to determine vacuitic uncertainty associated with the user model based on output of the risk-aware variant of the user model.

9. The method of claim 1, wherein the plurality of composable wrappers comprises a wrapper configured to determine epistemic uncertainty associated with the user model based on output of the risk-aware variant of the user model.

10. The method of claim 1, wherein the plurality of composable wrappers comprises a wrapper configured to determine aleatoric uncertainty associated with the user model based on output of the risk-aware variant of the user model.

11. The method of claim 1, further comprising:
iteratively:
determining, by the computer system, whether the list of risk metrics includes another risk metric;
in response to determining that the list of risk metrics includes the another risk metric, selecting, by the computer system, another composable wrapper from the plurality of composable wrappers based on the another risk metric; and
applying, by the computer system and for the selected another composable wrapper, another wrapper-specific algorithm to the risk-aware variant of the user model.

12. The method of claim 1, wherein applying the wrapper-specific algorithm to the user model comprises at least one of searching, adding, deleting, or replacing one or more nodes or subgraphs of the user model.

13. The method of claim 1, further comprising:
receiving, by the computer system, user inputs associated with the user model, the user input including training data having inputs and ground truth labels;
executing, by the computer system, the risk-aware variant of the user model based on the user inputs;
jointly optimizing, by the computer system, the risk-aware variant of the user model on one or more associated losses; and
returning, by the computer system, the optimized model.

14. The method of claim 13, wherein jointly optimizing, by the computer system, the risk-aware variant of the user model on one or more associated losses comprises:
computing a combined loss of an average of user-specified losses and wrapper losses for the risk-aware variant of the user model;
computing a gradient of the combined loss regarding one or more parameters of the risk-aware variant of the user model; and
updating one or more trainable parameters of the risk-aware variant of the user model based on the computed gradient.

15. A system for generating a risk-aware variant of a machine learning model, the system comprising:
a computer system having memory and processors configured to execute instructions that cause the computer system to perform operations comprising:
receiving, from at least one of a user device or a data store, a user model and a list of one or more risk metrics, wherein the one or more risk metrics indicate types of risk factors to assess for the user model;
selecting a composable wrapper from a plurality of composable wrappers for wrapping the user model based on a risk metric in the list of risk metrics, wherein at least some of the plurality of composable wrappers correspond to different types of risk factors, wherein each of the plurality of composable wrappers is configured to modify mathematical operations that the user model computes;
applying, for the selected composable wrapper, a wrapper-specific algorithm to the user model to generate a risk-aware variant of the user model, wherein applying the wrapper-specific algorithm to the user model comprises modifying the mathematical operations computed by the user model to produce a risk estimate for the user model and predictions of the user model;
iteratively:
determining whether the list of risk metrics includes another risk metric;
in response to determining that the list of risk metrics includes the another risk metric, selecting another composable wrapper from the plurality of composable wrappers based on the another risk metric; and
applying, for the selected another composable wrapper, another wrapper-specific algorithm to the risk-aware variant of the user model; and
returning the risk-aware variant of the user model.

16. The system of claim 15, wherein applying the wrapper-specific algorithm to the user model comprises:
applying one or more model modifications to the user model to generate a modified user model;
applying one or more model augmentations to the modified user model to generate an augmented user model; and
applying a loss function modified to the augmented model to generate the risk-aware variant of the user model.

17. The system of claim 15, wherein applying the wrapper-specific algorithm to the user model comprises providing an entire user model to the selected composable wrapper.

18. A system for performing a risk assessment on a machine learning model, the system comprising:
a computer system having memory and processors configured to execute instructions that cause the computer system to perform operations comprising:
receiving, from at least one of a user device or a data store, an arbitrary model and a list of one or more risk metrics, wherein the one or more risk metrics indicate types of risk factors to assess for the arbitrary model;
wrapping the arbitrary model in a composable wrapper, wherein the composable wrapper is configured to modify mathematical operations that the arbitrary model computes;
converting, based on execution of the composable wrapper, the arbitrary model into a risk-aware variant of the arbitrary model, wherein converting the arbitrary model into the risk-aware variant of the arbitrary model comprises:
(i) applying a wrapper-specific algorithm of the composable wrapper to the arbitrary model; and
(ii) modifying the mathematical operations computed by the arbitrary model to produce a risk estimate for the arbitrary model and predictions of the arbitrary model; and
returning the risk-aware variant of the arbitrary model.

19. The system of claim 18, wherein wrapping the risk-aware variant in the composable wrapper comprises:
(i) performing one or more wrapper-specific modifications to an architecture of the arbitrary model; and
(ii) at least one of creating, modifying, or combining existing loss functions for the arbitrary model.

20. The system of claim 19, wherein performing the one or more wrapper-specific modifications to the architecture of the arbitrary model comprises at least one of:
replacing one or more deterministic weights in the arbitrary model with stochastic distributions;
adding, deleting, replacing, or a combination thereof, one or more layers of the arbitrary model; or
augmenting the arbitrary model, wherein augmenting the arbitrary model comprises adding one or more extra layers to the arbitrary model.

21-47. (canceled)
